(19) United States
(12) Patent Application Publication
(10) Pub. No.: US 2024/0294084 A1
(43) Pub. Date: Sep. 5, 2024

(54) CHARGING STATION SYSTEM

(71) Applicant: Dean Solon, Gallatin, TN (US)

(72) Inventor: Dean Solon, Gallatin, TN (US)

(21) Appl. No.: 18/590,323

(22) Filed: Feb. 28, 2024

Related U.S. Application Data
(60) Provisional application No. 63/488,319, filed on Mar. 3, 2023.

(51) Int. Cl. B60L 53/35; B60L 53/65; B60L 58/12; H02J 7/00

(52) U.S. Cl. CPC B60L 53/35; B60L 53/65; B60L 58/12; H02J 7/0042

(57) ABSTRACT

A charging station system is disclosed. In some implementations, the charging station system includes control circuitry and a mechanical arm communicatively connected to the control circuitry. The mechanical arm is configured to adjust a dispensing location of a charging cord. The dispensing location is adjustable to different locations based on at least a first location of a first charging receptacle of a first vehicle and a second location of a second charging receptacle of a second vehicle. The second location is further from a power source than the first location.

### CLAIM OF PRIORITY

This application claims priority to U.S. Provisional Application Ser. No. 63/488,319, filed on Mar. 3, 2023, the entire contents of which are hereby incorporated by reference.

### BACKGROUND

This specification relates to improvements to charging stations, such as electronic vehicle (EV) charging stations. An electric vehicle charging station is a device that provides electric energy to recharge the battery of an electric vehicle. A charging port physically connects to the car and enables power to flow from the EV charging station to the car by way of a cord that connects the charging port to the charger of the EV charging station.

### SUMMARY

In general, one innovative aspect of the subject matter described in this specification can be embodied in a system including control circuitry; and a mechanical arm communicatively connected to the control circuitry and configured to adjust a dispensing location of a charging cord. The dispensing location is adjustable to different locations based on at least a first location of a first charging receptacle of a first vehicle and a second location of a second charging receptacle of a second vehicle, wherein the second location is further from a power source than the first location.

These and other embodiments can each optionally include one or more of the following features. The system can include a mobile base configured to (i) move the mechanical arm toward a power source configured to provide power to the charging cord and (ii) move the mechanical arm away from the power source configured to provide power to the charging cord.

The mechanical arm can be attached to the mobile base and configured to move up and down the mobile base based on a first height of the first charging receptacle and a second height of the second charging receptacle.

Th system can include a receptacle detection apparatus that includes one or more sensors and one or more processors. The receptacle detection apparatus can be configured to perform operations including detecting, based on data collected using the one or more sensors, the first location of the first charging receptacle or the second location of the second charging receptacle; and aligning a physical location of a charging port of a charging station based on the detecting of the first location of the first charging receptacle or the second location of the second charging receptacle.

The receptacle detection apparatus can be configured to perform operations including:
connecting the charging port to a given charging receptacle; and initiating charging, by the charging station, based, at least in part, on the charging port being electrically connected to the given charging receptacle.

The receptacle detection apparatus can be configured to perform operations including: detecting when charging is complete; and retracting the charging port from the given charging receptacle after the charging is complete. Detecting when the charging is complete can include detecting one or more of (i) when a charge cycle is complete while the charging port is still connected to the given charging receptacle or (ii) when the charging port has been physically removed from the given charging receptacle. Retracting the charging port can include one or more of (i) re-spooling a section of the charging cord or (ii) retracting a portion of a telescoping portion or folding portion of the mechanical arm.

The base can be located on an opposite side of a parking block than a power source providing power to the charging cord; and the charging cord can electrically connect the base to the power source. The charging cord can be routed through the parking block.

The mechanical arm can include a telescoping portion or a folding portion; and a cord dispenser attached to the telescoping portion or the folding portion. The cord dispenser can be configured to dispense and retract a portion of the charging cord. The cord dispenser can include a spring retraction mechanism configured to retract the charging cord. The cord dispenser can include a motorized retraction mechanism.

The system can include control circuitry configured to perform operations including identifying characteristics of a vehicle that is located within a given physical area. The control circuitry can be configured to perform operations including adjusting charging parameters of the charging station based on the characteristics of the vehicle that is located within the given physical area; and moving the mechanical arm to a specified position based on the characteristics of the vehicle that is located within the given physical area.

The control circuitry can be configured to perform operations further comprising monitoring a charge state of the vehicle; and moving the mechanical arm to a designated location based on the charge state of the vehicle reaching a charge complete state.

The system can include a solar power collection system configured to provide power to an electric vehicle charging station that includes the charger.

The system can include a parking block. The parking block can be configured to have a top surface; and a bottom surface, where the bottom surface is configured to be closer to the ground than the top surface when the parking block is in an installed state. The parking block can have a cord channel defined at a location within the parking block that is between the top surface and the bottom surface; and the cord channel can be a void configured to accept a cord that connects an electric vehicle (EV) charger to an EV charging port configured to physically connect to an EV. The cord channel can be accessible through the bottom surface of the parking block. The cord channel can be accessible from an exterior surface of the parking block. The cord channel can be accessible from two exterior surfaces of the parking block.

Another innovative aspect of the subject matter described in this specification can be embodied in a method that includes one or more of detecting an EV in physical proximity to a sensor; obtaining information about the EV; detecting a location of a given charging receptacle of the EV; adjusting a dispensing location of a charging cord base on the location of the given charging receptacle; aligning the physical location of a charging port within the given charging receptacle; connecting the charging port to the given charging receptacle; charging the EV; retracting the charging port when the charge complete state is reached; and moving the mechanical arm to a designated location after the charge complete state is reached.

Particular embodiments of the subject matter described in this specification can be implemented so as to realize one or more of the following advantages. For example, the subject matter described herein can prevent cords of EV charging stations (also referred to as charging stations for brevity) from being strewn across the ground, which reduces tripping hazards for users of charging stations, as well as pedestrians walking in the vicinity of the charging stations. For example, a new parking block (also known as a car stop) configured to route the cord through the parking block can be used to eliminate trip hazards that would be caused by leaving the cord exposed (e.g., laying on the ground). Because parking blocks are already used to mark the edge of a parking space and prevent cars from hitting the charging station (or other objects), routing the cord through the specially configured parking block eliminates any additional tripping hazards that would have otherwise been caused by an exposed cord.

As discussed in more detail below, the solutions described herein can also be configured using lower profile (e.g., flattened) cords that connect the charger of the charging station to the charging port. These lower profile cords reduce the height of any cords that are placed on the ground relative to the high profile (e.g., round) cords that are conventionally used.

The solutions described herein can also reduce the size of, or eliminate the need for, the structures previously used to house components of an EV charging station. For example, one or more of the components of the EV charging station can be incorporated into a parking block and/or a mechanical arm (or another structure) that is located closer to the designated parking location for an EV being charged. In some situations, the components housed in the parking block can plug directly into a low frequency (e.g., 50-60 Hz) AC power source, and condition the low frequency AC power for use in charging an EV. In some implementations, the components housed in the parking block can receive high frequency AC power (e.g., greater than 100 Hz, 200 Hz, 400 Hz, or 1000 Hz) from a step-up transformer that is plugged into the low frequency AC power source (or connected to a component of the EV charging station), and direct the high frequency AC power to other circuitry located closer to a charging port than the parking block. In some situations, the parking block can include a step-down transformer and/or a rectifier that reduces the frequency of the received high frequency AC power (potentially to DC), and provides the output power to the charging port or circuitry that is closer (e.g., electrically closer and/or physically closer) to the charging port than the components included in the parking block. By transferring the power at higher frequencies, smaller conductors can be used, which reduces the trip hazards associated with cabling that is exposed in the area designated for EV charging.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an illustration of a vehicle connected to an EV charging station.

FIGS. 2A-2K are illustrations showing different configurations of a cord channel formed in a parking block.

FIGS. 3A-3D are illustrations depicting different configurations of cord channels.

FIGS. 4A-4K are illustrations depicting different configurations of a mechanical arm of a charging station.

FIGS. 5A and 5B are illustrations of a robot charging assistant.

FIGS. 6A and 6B are illustrations of an automated charging system in a parking structure.

FIG. 7 is an illustration of a configuration in which high frequency Alternating Current (“AC”) power used to facilitate EV charging.

FIG. 8 is a flow chart of an example process for controlling a mechanical arm.

Like reference numbers and designations in the various drawings indicate like elements.

### DETAILED DESCRIPTION

The present specification describes methods, systems, and computer readable medium for implementing charging station system improvements. The charging station system can include for example, a set of components can be used to reduce, or eliminate, trip hazards associated with charging station cords being strewn across the ground, or piled up, near a charging station. In some implementations, a system can include a base that is configured to be secured to a supporting surface, such as the ground, concrete, a wall, a ceiling, or a mobile supporting surface (e.g., wheel assembly, track system, or treads), and a mechanical arm that is connected to the base. The mechanical arm is configured to adjust a power dispensing location of a charging cord and/or charging port of a charging system (e.g., Electric Vehicle (EV) charging station). For example, the charging port and/or charging cord of a charging station can be housed in, or attached to, the mechanical arm, and depending on the location of the charging receptacle on an EV, the mechanical arm can move the charging port and/or charging cord to closer to the charging receptacle so that less charging cord has to be dispensed, which can reduce, or prevent, the charging cord from being on the ground. In some situations, the mechanical arm can automatically insert the charging port into the charging receptacle of an EV, such that the charging process can be automated, and prevent any of the charging cord from contacting the ground and/or being exposed. As discussed in more detail below, the mechanical arm can have a fixed base that doesn't move, and the mechanical arm can either telescope or unfold to adjust the location of the charging port and/or charging cord. Alternatively, the mechanical arm can have a mobile base that can move (e.g., along a track or using treads or wheels that are not on a track) to position the charging port and/or charging cord closer to the charging receptacle of an EV.

The present specification also describes systems and methods for implementing a parking block that reduces trip hazards caused by cords of an electric vehicle (EV) charging station. As described in more detail below, a specially configured parking block can be used to hide a charging cord connecting the charger of the charging station to the charging port (e.g., the plug that connects to the EV). For example, the parking block can be formed to have a cord channel (e.g., a void) through which the charging cord can be routed. By routing the charging cord through the cord channel of the parking block, the cord is no longer exposed, such that the cord is no longer a trip hazard. In some implementations, the cord channel can be round, or otherwise have an arced shape so that round charging cables can be routed through the cord channel. In some implementations, the cord channel is rectangular to accept flat (e.g., rectangular) cables, such as ribbon cables. Using flat cables can lower the profile of the charging cable so that any exposed cable (e.g., between the charging station and the parking block or between the parking block and the charging port) is less of a trip hazard than the round charging cables currently being used. As discussed below, these parking blocks can be used in combination with mechanical arms to further reduce the amount of the charging cord that is exposed and/or laying on the ground.

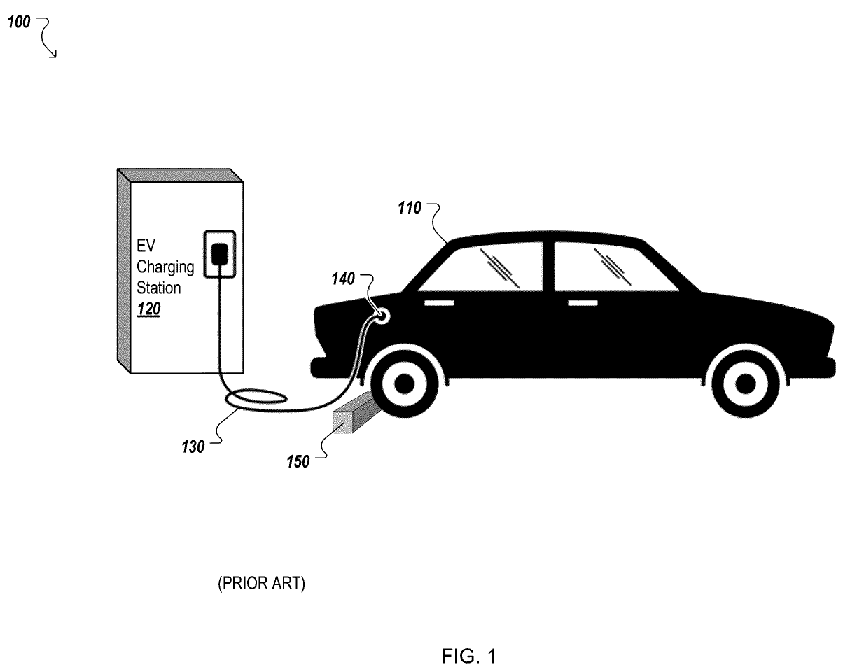

FIG. 1 is an illustration 100 of an electronic vehicle (EV) 110 connected to an EV charging station 120. As shown, the charging station 120 has a charging cord 130 that connects the charger of the charging station 120 to a charging port 140 of the charging station 120, which physically connects the charging station 120 to the EV 110. Usually, the charging cord 130 is very long (e.g., at least the length of the vehicles intended to be charged), so that the charging port 140 at the end of the charging cord 130 can reach a charging receptacle of the car that receives the charging port 140 of the charging station 120. For example, while the EV 110 is shown with the charging port 140 connected at an end of the EV 110 that is closest to the charging station 120, but the charging cord 130 is generally long enough to reach the opposite end of the EV 110 so that the charging port 140 can still be connected to the EV 110 if its charging receptacle was located at the other end of the EV 110, or the EV 110 pulled into the parking space in the opposite direction. Furthermore, it is common to use a parking block 150 to maintain a safe distance between the EV 110 and the charging station 120, which increases the length of the charging cord 130 that is needed to ensure the charging port 140 can reach the EV 110. This often results in portions of the charging cord 130 being placed on the ground, either strewn about, or piled up, which creates a significant tripping hazard to people walking, or otherwise moving about, near the exposed charging cord 130.

A parking block is a device generally used to indicate the proper parking spot for a vehicle and maintain a safe distance between the vehicle and other objects, such as walls, buildings, walkways and charging stations. The parking block 150 can be made of concrete, plastic, rubber, or another appropriate rigid material, and is placed along the edge of a parking space to physically prevent a vehicle from rolling over the curb or into another space. The parking block 150 can be secured to the ground using anchor bolts. For example, the parking block 150 can be drilled and then bolted to the surface of the pavement or concrete using concrete anchors. The anchors often include a threaded rod, typically made of steel, that is embedded into the concrete, with a nut and washer on the end to hold the block in place. In some cases, adhesive may also be used in conjunction with the anchor bolts to provide added stability and security. Once installed, the parking block 150 is generally not movable, and the charging cord 130 is often laid over the parking block 150 when the charging port 140 is attached to the EV 110, which increases the trip hazard of the charging cord 130 because it is now elevated off the ground, rather than laying flat.

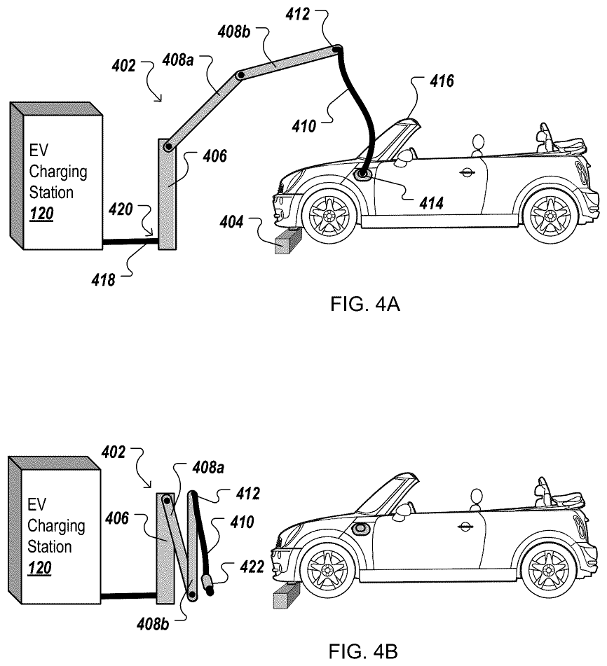

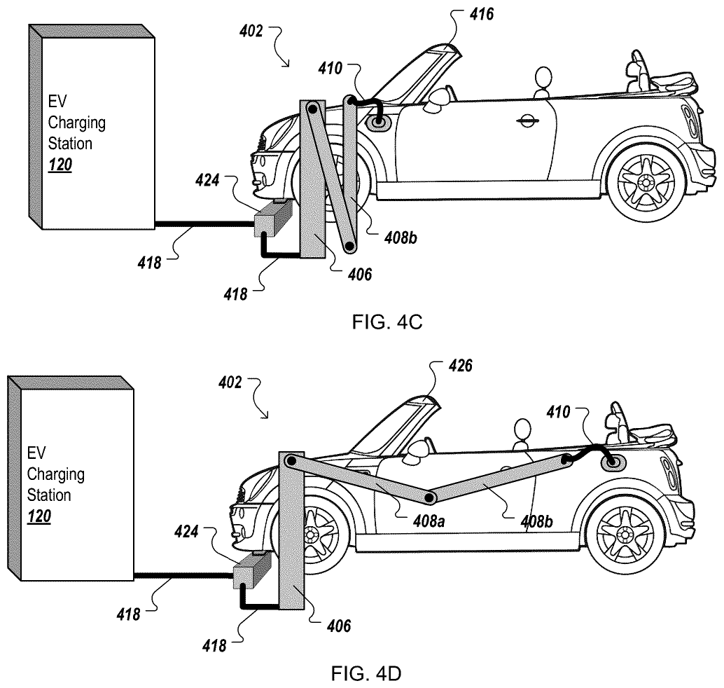

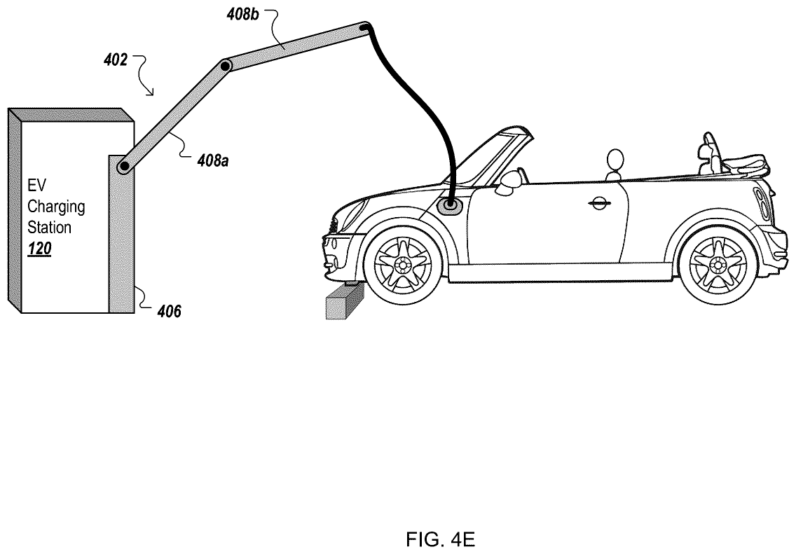

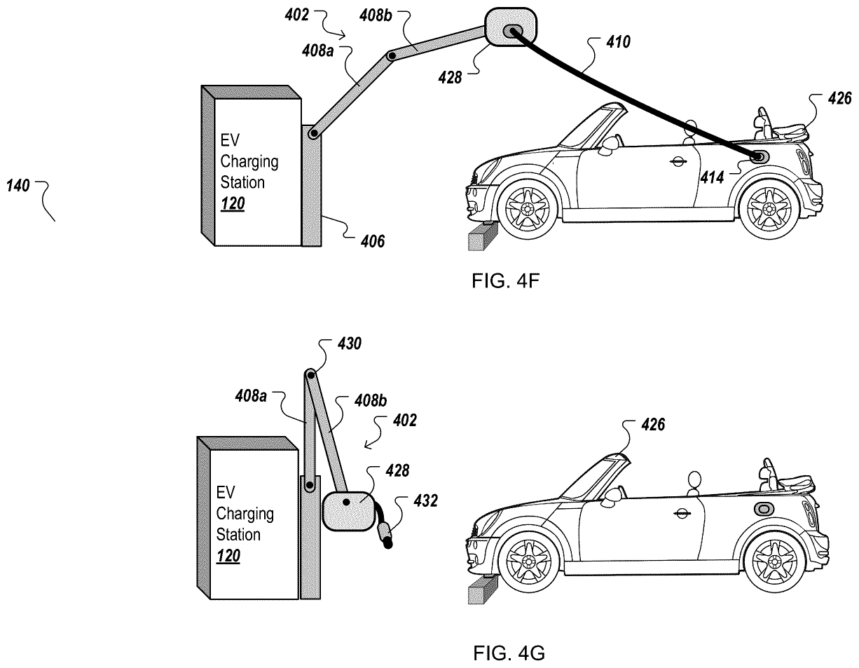

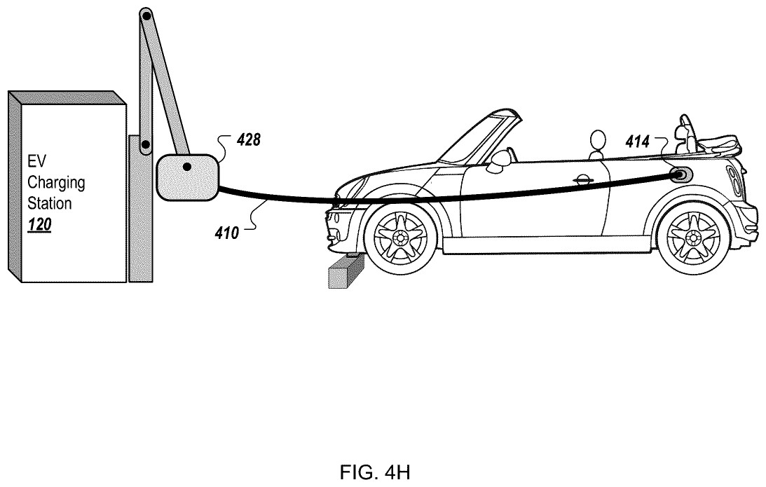

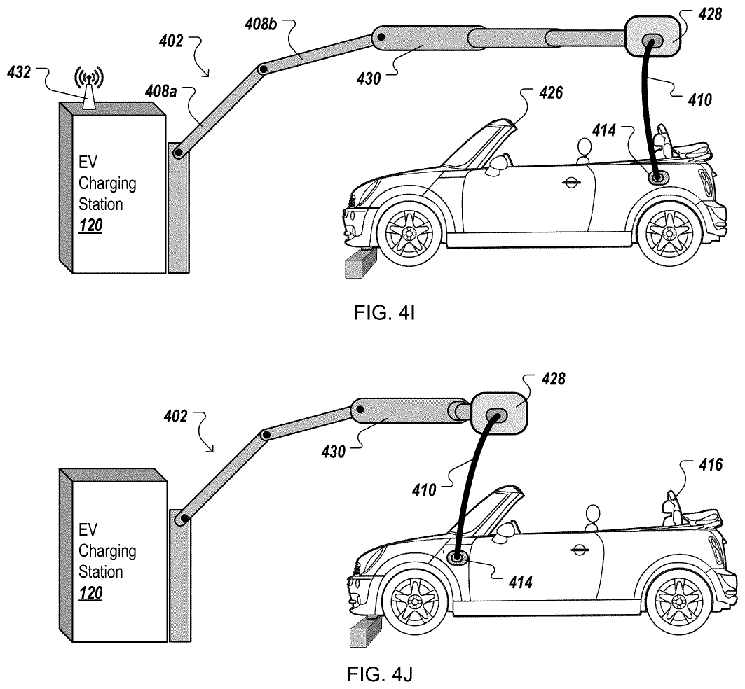

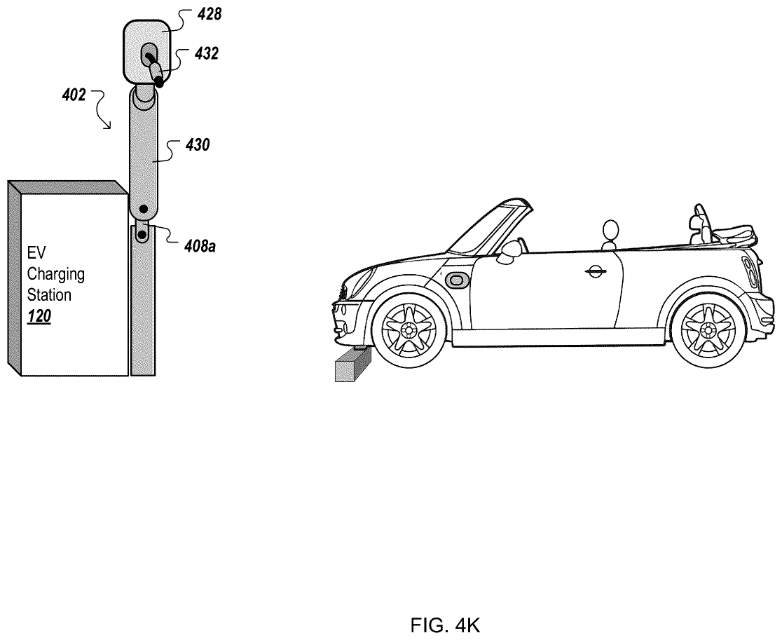

The trip hazard caused by charging cords that are laying on the ground and/or elevated off the ground by parking blocks can be reduced or eliminated by using specially configured parking blocks through which the charging cords can be routed. For example, as discussed more below, a parking block can have a cord channel created through a body of the parking block so that the charging cord can pass through, and be obscured by, the parking block. The cord channel can take many different forms, and pass-through different portions of the parking block depending on the location/arrangement of the charging station, among other factors. Furthermore, as discussed in detail with reference to FIGS. 4A-4C, a set of multiple parking blocks can be manufactured as a series of electrically connected parking blocks that are interconnected by a set of conductors (e.g., wires or charging cords). These set of conductors can be flexible so that the parking blocks can be arranged in a “stacked” configuration for transport, and then unstacked/unfolded at the desired installation location in a ready for use fashion.

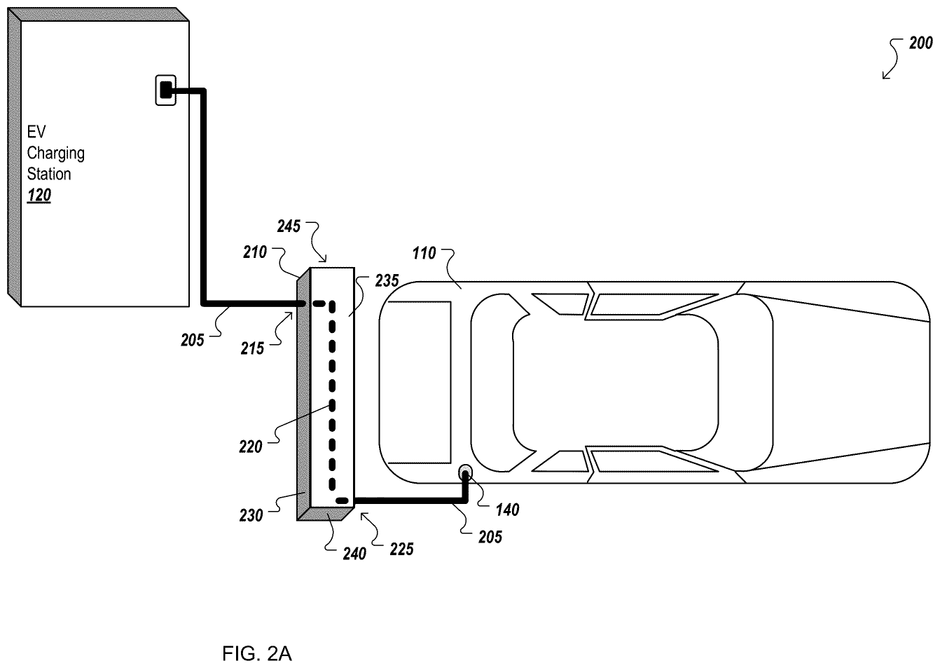

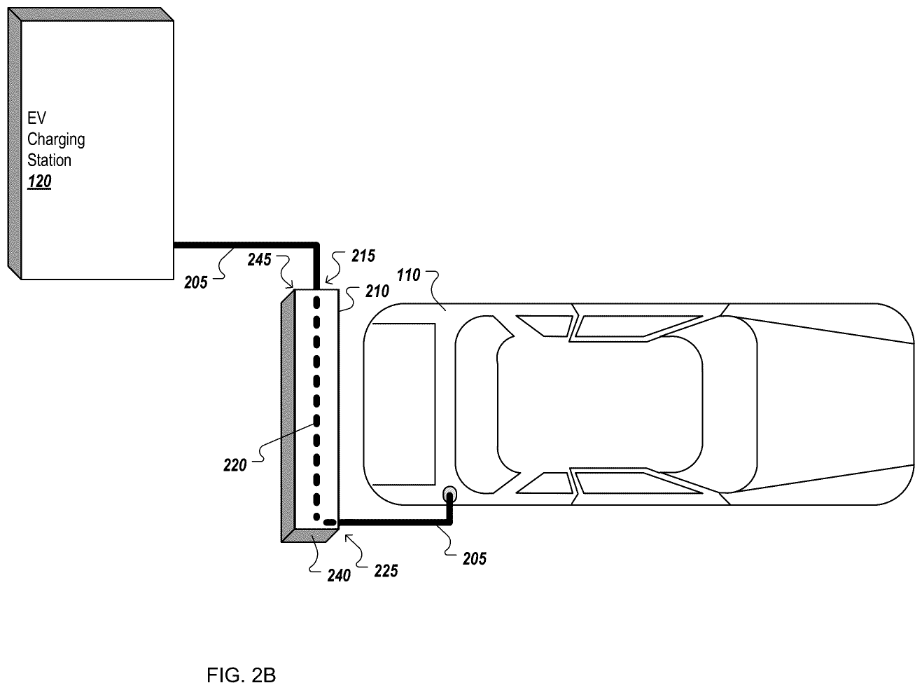

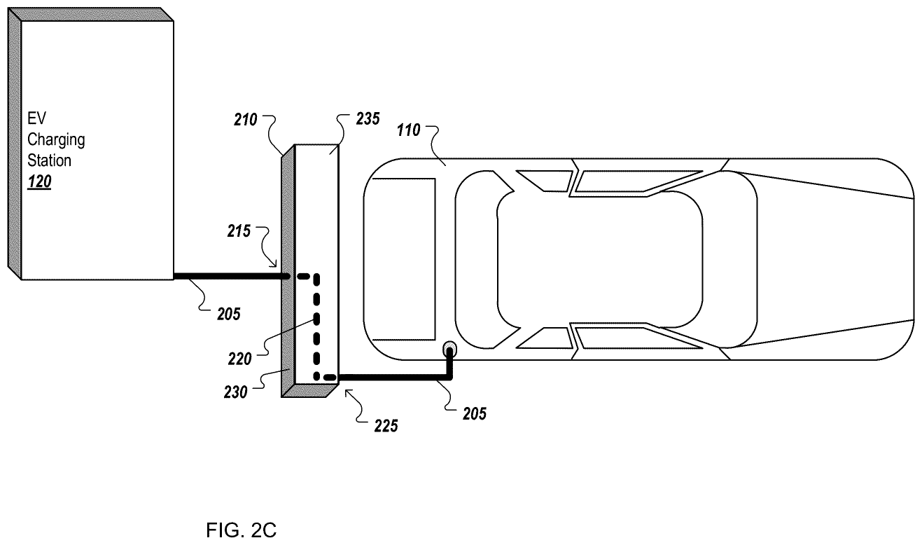

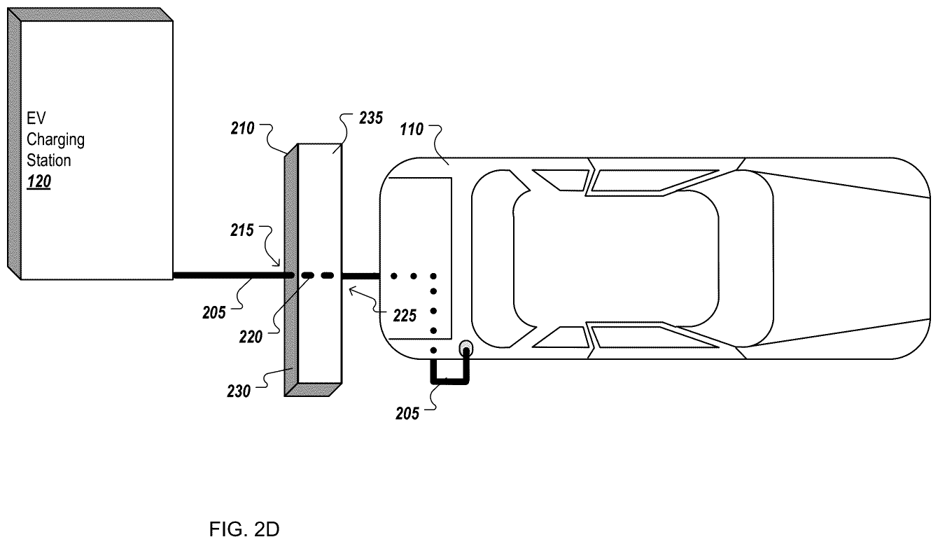

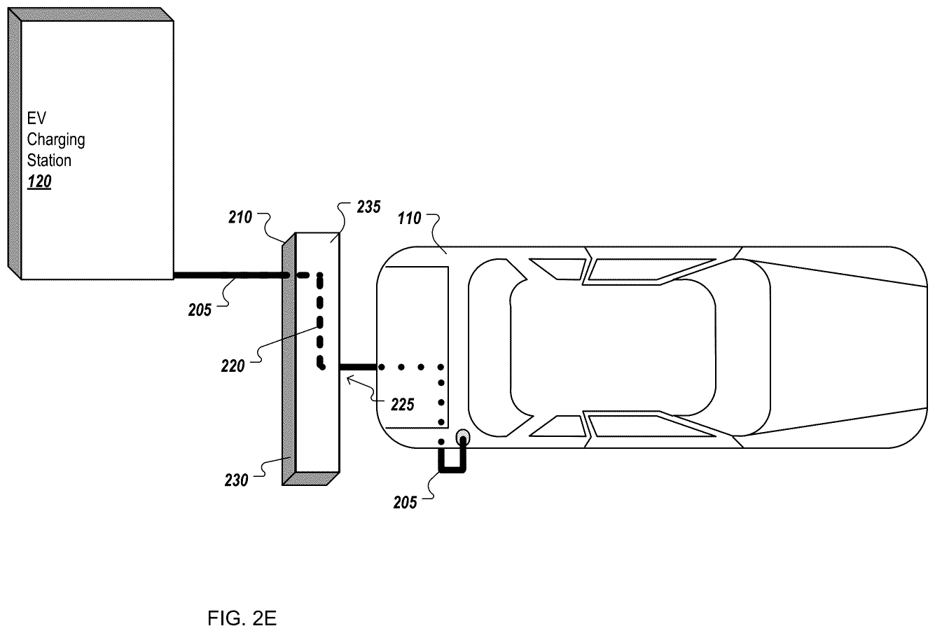

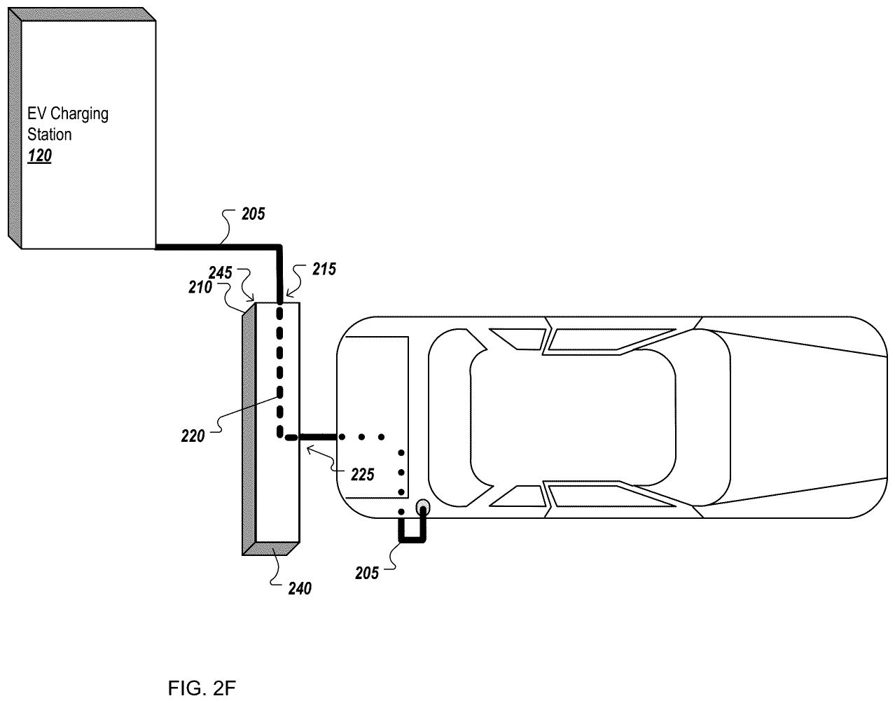

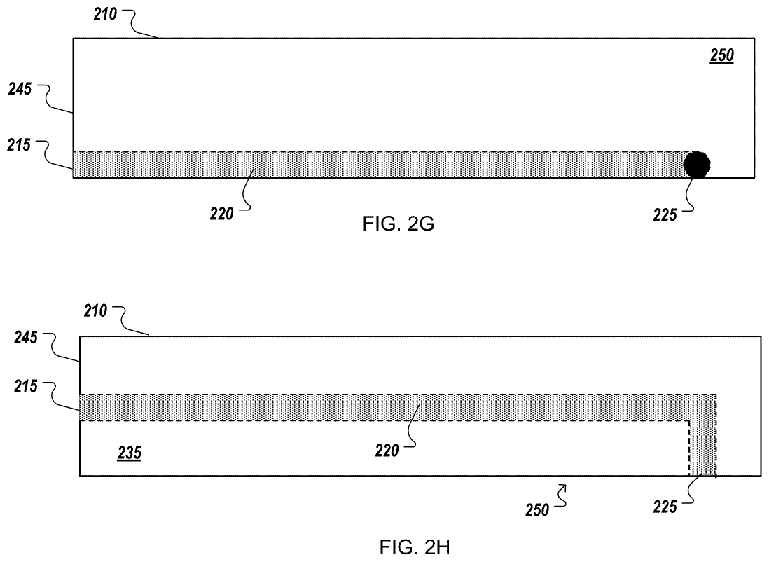

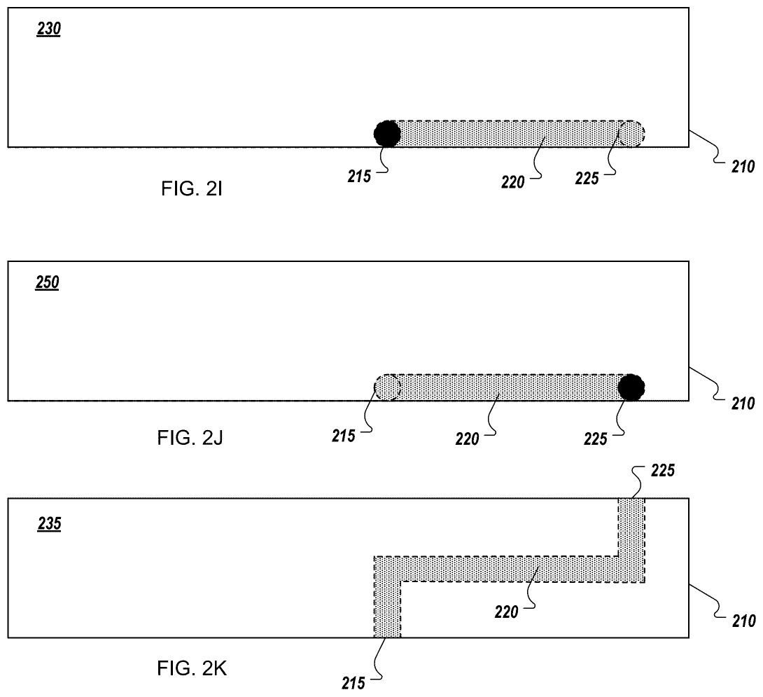

FIG. 2A is an illustration 200 of a charging cord 205 routed through a parking block 210. As shown, the charging cord 205 connects the charging station 120 to the charging port, which is physically connected to the EV 110. The charging cord 205 enters the parking block 210 at an entry port 215, is routed through a cord channel 220 that is defined in a body of the parking block 210 and exits the parking block 210 at an exit port 225. The parking block 210 of FIG. 2A is configured with the entry port 215 defined (e.g., created) in a first side surface 230 of the parking block 210, and the exit port 225 is defined in a second side surface (not visible) that is on an opposite side of the parking block 210 than the first side surface 230.

As used herein, a side surface of a parking block refers to a face of the parking block that is (i) between a top surface and a bottom surface of the parking block, and (ii) has a larger surface area than an end of the parking block that is between the side surface and an opposite side surface that is on an opposite side of the top surface and bottom surface. For example, as shown in FIG. 2A, the first side surface 230 is located (i) between the top surface 235 and the bottom surface (not visible) of the parking block 210 and (ii) has a larger surface area than the side 240 that is between the first side surface 230 and the second side surface (not visible) that is on the opposite side of the top surface and the bottom surface relative to the first side surface. Exterior surfaces of a parking block include side surfaces (e.g., 230), end surfaces (e.g., 240), the top surface (e.g., 235), and the bottom surface.

The top surface 235 of the parking block is generally configured to be further from the ground when the parking block 210 is installed (e.g., in an installed state), while the bottom surface of the parking block 210 is configured to be closer to the ground (e.g., in contact with the ground or one or more materials that are in between the parking block 210 and the ground) when the parking block 210 is installed (e.g., in an installed state). In some implementations, the parking block 210 is considered to be in an installed state when it is bolted, glued, or otherwise secured to the ground (or a surface between the ground and the parking block 210).

As mentioned above, the cord channel 220 is defined in the body of the parking block 210. In other words, the cord channel 220 is created at a location within the parking block that is between the top surface 235 and the bottom surface (inclusive). In some implementations, the cord channel can be defined by creating a void in the material of the parking block. The void can be configured (e.g., sized, and shaped) to accept the charging cord 205 that connects the EV charging station 120 to the EV 110 (e.g., by way of a charging port).

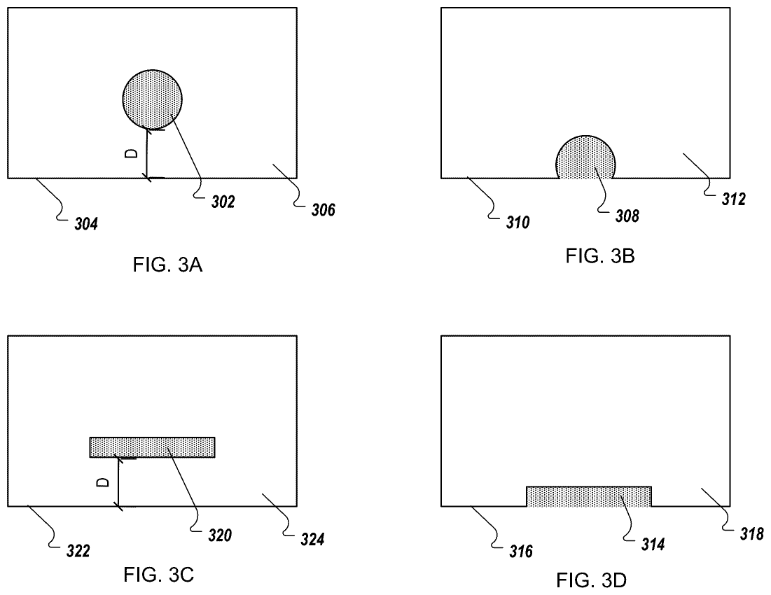

As shown in FIGS. 3A-3D, which are illustrations depicting different configurations of cord channels, the void defining the cord channel can be created in different ways (e.g., different geometric shapes or locations), such that the cord channel can be accessed in different ways. For example, as shown in FIG. 3A, the cord channel 302 is created as a round void that is formed at a specified distance (D) from the bottom surface 304 of the parking block 306. When configured in this manner, the cord channel is accessible from/through a side surface or end surface of the parking block but is not accessible from/through the bottom surface 304 of the parking block 306. The round shape of the cord channel 302 configures the parking block for use with round cords (e.g., EV charging cords or other conductors). In other words, the cord channel 302 is configured to accept round charging cords based on the perimeter of the cord channel being arced/rounded.

FIG. 3B shows another configuration of a cord channel 308. In this configuration, the cord channel is accessible through the bottom surface 310 of the parking block 312, and again configured to accept round cords, such as round charging cords. The cord channel 308 is accessible through the bottom surface 310 because the void defining the cord channel 308 removes a portion of the bottom surface 310, such that a cord can be inserted into the parking block 312 through the opening in the bottom surface 310. The round shape of the void configures the cord channel 308 for use with round conductors.

FIG. 3C shows another configuration of a cord channel 314 that is accessible through a bottom surface 316 of a parking block 318 because a cord (e.g., charging cord) can be inserted into the cord channel 314 from the bottom of the parking block 318. This cord channel 314 is rectangular in shape thereby configuring it to accept flat (e.g., rectangular) cords, such as ribbon cables. Using flat cords reduces the profile (e.g., height) of the cords, which reduces the trip hazard relative to round cords having a similar electrical rating because the metal required to achieve a particular electrical rating is spread over a wider area, which reduces the height of the cord.

FIG. 3D shows the cord channel 320 being created at a distance D from the bottom surface 322 of the parking block 324. As shown, the cord channel is accessible from/through an exterior surface (e.g., a side surface or end surface) of the parking block 324 but is not accessible from/through the bottom surface 322 of the parking block 324. The angled/rectangular shape of the cord channel 320 perimeter configures the parking block for use with flat/rectangular cords (e.g., EV charging cords or other conductors), such as ribbon cables. In other words, the cord channel 320 is configured to accept flat/rectangular charging cords.

Returning to the discussion of FIG. 2A, as previously described, the cord channel 220 is accessible from two exterior surfaces of the parking block 210, the first side 230 and the second side. The entry port 215 is created/formed in, and accessible from, the first side 230, and in this particular configuration, the entry port 215 is formed in a side ⅓ of the parking block 210. To illustrate, assume that the parking block 210 is delineated into equal ⅓ sections. Once delineated, the location of the entry port 215 of the cord channel 220 is located outside of the middle ⅓ section of the parking block 210, such that the entry port 215 is necessarily located in one of the ⅓ side sections of the parking block 210. As such, the cord channel is formed through the side surface at a location that is outside of the middle ⅓ section of the first side 230. Of course, cord channel 220, as well as the rest of the cord channels discussed herein, can be formed to be accessible from the bottom surface of the parking block 210, or it can be formed at a specified distance from the bottom surface and/or top surface 235 of the parking block 210.

The cord channel 220 is configured to route the charging cord 205 from the entry port 215, which is near one end 245 of the parking block 210, to the exit port 225, which is defined in the second side and closer to the opposite end 240 of the parking block 210 than the entry port 215. As such, a first distance from an end surface of the parking block at which the cord channel 220 passes through a plane defined by the first side 230 (e.g., at the entry port 215) differs from the distance from the end surface at which the cord channel passed through another plane defined by the second side (e.g., at the exit port 225). In other words, the cord 205 enters the entry port 215 at a location that is offset (relative to the end) from the exit port 225 where the cord 205 exits the parking block.

In the particular configuration shown, the exit port 225 of the cord channel 220 is formed in the second side at a location that is outside of the middle ⅓ section of the parking block 210. As such, the cord channel is defined in and accessible from each of two exterior surfaces (e.g., the first side 230 and the second side), and is configured as a continuous void that extends between and through each of the two exterior surfaces. This enables the charging cord 205 to be routed through the parking block 210, thereby reducing the trip hazard posed by the charging cord 205 by housing a portion of the charging cord 205 that would normally be laying on the ground exposed. Configuring the cord channel in the manner shown in FIG. 2A, the charging cord 205 can be safely routed through the parking block 210 to a location that is closer to a charging port of the EV 110. Other configurations can also be used depending on the arrangement of items and/or the target application. Some of these configurations are described with reference to FIGS. 2B-2K.

FIG. 2B shows another configuration of the cord channel 220. In this configuration, the cord channel 220 still passes through, and is accessible from two exterior surfaces of the parking block 210, but rather than being defined in two opposite sides of the parking block 210, the cord channel 220 is defined in, and accessible from, the end 245 and the second side (not visible). For example, the entry port 215 is located in the end 245, and the exit port 225 is in the same section (e.g., outside of the middle ⅓ section) of the parking block 210, as discussed above with reference to FIG. 2A. The entry port 215 and the exit port 225 are connected by a continuous void defining the cord channel 220. This configuration causes the portion of the cord that emits from the exit port 225 to be offset from the center of the parking block 210.

In this configuration, the second side and the end 245 meet to form a corner of the parking block 210, and the end 245 has a smaller surface area than the second side. Like the configuration of FIG. 2A, this configuration enables routing the charging cord through the parking block, and from one end 245 of the parking block 210 to the other end 240 of the parking block 210, which shields the charging cord 205, and reduces the tripping hazard posed by an exposed charging cord laying on the ground.

FIG. 2C shows another configuration of the cord channel 220. In this configuration, the cord channel 220 still passes through, and is accessible from two exterior surfaces of the parking block 210, and like the configuration of FIG. 2A, the cord channel 220 is defined in two opposite sides of the parking block 210. Specifically, the cord channel 220 is again defined in, and accessible from, the first side 230 and the second side (not visible). For example, the entry port 215 is located in, and formed through, the first side 230, and the exit port 225 is located in, and formed through the second side (e.g., a car facing side of the parking block when in an installed state), that is on the opposite side of the top surface 235 than the first side 230. The exit port 225 is in the same section (e.g., outside of the middle ⅓ section) of the parking block 210, as discussed above with reference to FIG. 2A, but the entry port 215 is in the middle ⅓ section of the parking block 210. The entry port 215 and the exit port 225 are connected by a continuous void defining the cord channel 220. This configuration can be useful, for example, when the charging station 120 is located in a position such that the middle ⅓ section of the parking block 210 is closer to the charging station 120 than sections of the parking block 210 outside of the middle ⅓ section.

FIG. 2D shows another configuration of the cord channel 220. In this configuration, the cord channel 220 still passes through, and is accessible from two exterior surfaces of the parking block 210, and like the configuration of FIG. 2A, the cord channel 220 is defined in two opposite sides of the parking block 210. Specifically, the cord channel 220 is again defined in, and accessible from, the first side 230 and the second side (not visible). For example, the entry port 215 is located in, and formed through, the first side 230, and the exit port 225 is located in, and formed through the second side (e.g., a car facing side of the parking block when in an installed state), that is on the opposite side of the top surface 235 than the first side 230. In this configuration, both of the entry port 215 and the exit port 225 are located in the middle ⅓ section of the parking block 210. The entry port 215 and the exit port 225 are connected by a continuous void defining the cord channel 220. This configuration can be useful, for example, when the charging station 120 is located in a position such that the middle ⅓ section of the parking block 210 is closer to the charging station 120 than sections of the parking block 210 outside of the middle ⅓ section, and the charging cord 205 is to be routed under the EV 110, as illustrated by the dotted lines.

FIG. 2E shows another configuration of the cord channel 220. In this configuration, the cord channel 220 still passes through, and is accessible from two exterior surfaces of the parking block 210, and like the configuration of FIG. 2A, the cord channel 220 is defined in two opposite sides of the parking block 210. Specifically, the cord channel 220 is again defined in, and accessible from, the first side 230 and the second side (not visible). For example, the entry port 215 is located in, and formed through, the first side 230, and the exit port 225 is located in, and formed through the second side (e.g., a car facing side of the parking block when in an installed state), that is on the opposite side of the top surface 235 than the first side 230. In this configuration, the exit port 225 is located in the middle ⅓ section of the parking block 210, but the entry port 215 is located outside of the middle ⅓ section of the parking block 210. The entry port 215 and the exit port 225 are connected by a continuous void defining the cord channel 220. This configuration can be useful, for example, when the charging station 120 is located in a position such that a ⅓ section of the parking block 210 outside of the middle ⅓ section is closer to the charging station 120 than sections of the parking block 210 the middle ⅓ section, and the charging cord 205 is to be routed under the EV 110, as illustrated by the dotted lines.

FIG. 2F shows another configuration of the cord channel 220. In this configuration, the cord channel 220 still passes through, and is accessible from two exterior surfaces of the parking block 210, but rather than being defined in two opposite sides of the parking block 210, the cord channel 220 is defined in, and accessible from, the end 245 and the second side (not visible). For example, the entry port 215 is located in the end 245, and the exit port 225 is in the middle ⅓ section of the parking block 210. The end 245 has a smaller surface area than the second side, a corner of the parking block 210 is defined by the end 245 and the second side. The entry port 215 and the exit port 225 are connected by a continuous void defining the cord channel 220. This configuration can be useful, for example, when the charging station 120 is located in a position such that the end 245 of the parking block 210 is closest to the charging station 120, and the charging cord 205 is to be routed under the EV 110 (e.g., in a middle section of a parking space), as illustrated by the dotted lines.

FIG. 2G is a side view of the parking block 210 showing the exit port 225 located outside of the middle ⅓ section of the parking block 210. In this configuration, the exit port 225 of the cord channel 220 is formed in, and accessible from, the second side 250. FIG. 2G also shows how the cord channel 220 extends from the exit port 225 to the entry port 215, which is formed in the end 245 of the parking block 210. The textured fill used to depict the cord channel 220 in these figures indicates that the cord channel 220 is formed within the body of the parking block 210 rather than the surface being viewed.

FIG. 2H is a top view of the parking block 210, which shows how the cord channel 220, as depicted in FIG. 2G is formed through the body of the parking block 210. More specifically, FIG. 2G is looking at the cord channel 220 through the top surface 235 and shows how the cord channel is formed from the entry port 215 at the end 245 to the exit port 225. In this configuration, the void defining the cord channel is created down a middle portion of the parking block 210, and then has a 90 degree turn toward the second side 250. Of course, angles other than a single 90-degree angle could be used (e.g., 45 degrees). Also, the cord channel 220 could be curved, rather than angled. Further, the cord channel could be configured to accommodate flat cords, as discussed with reference to FIGS. 3C and 3D.

FIGS. 2I-2K are different views of an example cord channel 220 as configured in FIG. 2C. In these figures, the entry port 215 is located in the middle ⅓ section of the parking block 210, and the exit port 225 is located outside of the middle ⅓ section of the parking block 210. FIG. 2I is a side view of the parking block with the first side 230 shown. The entry port 215 is shown as being formed through the side 230, and the cord channel 220 is formed by a void that extends through the body of the parking block 210 from the entry port 215 to the exit port 225, which is formed in the second side. FIG. 2J is an opposite side view of the parking block 210 with the second side 250 showing. The exit port 225 is shown as being formed through the side 250, and FIG. 2J shows the cord channel 220 as a void that extends through the body of the parking block 210 from the entry port 215 to the exit port 225. FIG. 2K is a top view of the parking block 210 showing the path of the cord channel 225 within the body of the parking block 210 and between the entry port 215 and the exit port 225.

FIGS. 4A-4H are illustrations depicting different configurations of a mechanical arm of a charging station. FIG. 4A is an illustration of a mechanical arm 402 that is installed on a same side of a parking block 404 as the EV charging station 120. The mechanical arm 402 has a base 406 that is configured to be secured to a surface, or the base 406 can be freestanding. The base 406 is depicted as being in direct contact with the ground (e.g., in a post hole), but the base could be attached to a metal plate, concrete, a wall, or another structure (e.g., a wheel assembly, tread structure, or a track structure). The mechanical arm 402 also has multiple extension members 408a and 408b, which can also be referred to as “links” or “segments” of the mechanical arm 402.

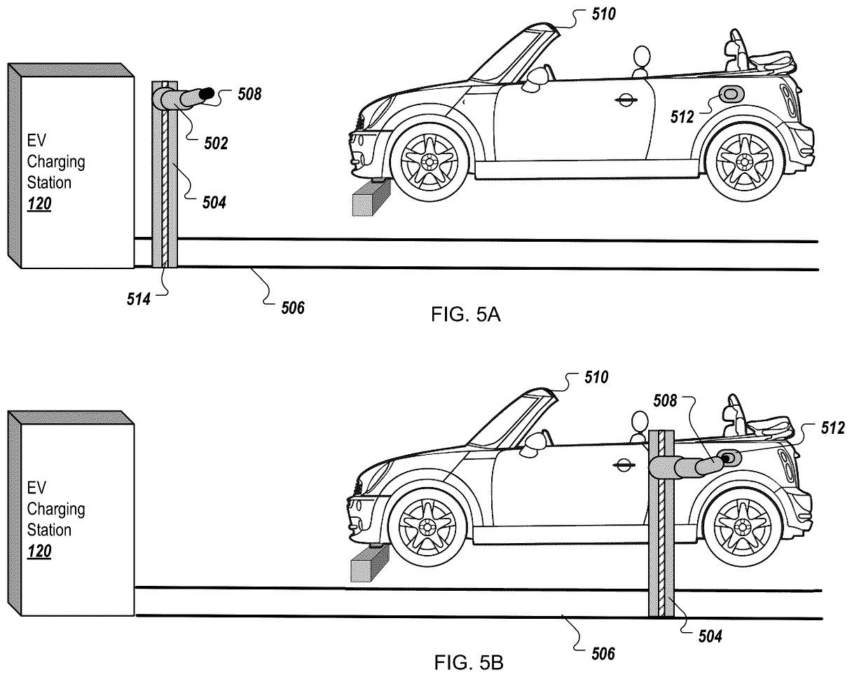

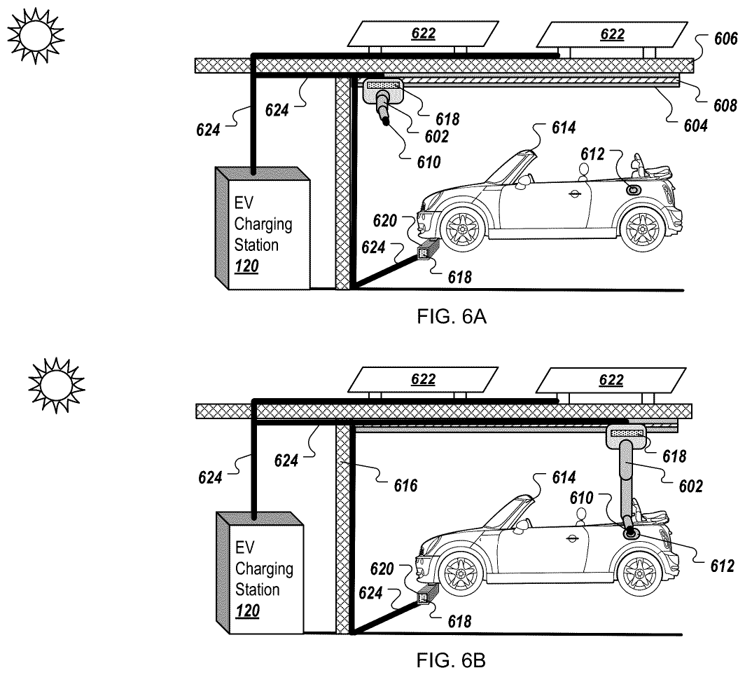

The extension members 408a and 408b can be attached to one another through various types of joints such as rotary or linear joints to form the mechanical arm 402. The number and type of links used in a mechanical arm depend on the intended use and required range of motion. FIG. 4A shows the mechanical arm 402 implemented with two extension members 408a and 408b that are pivotally attached to each other, and to the base 406. Additional components can be attached to the extension members 408a and 408b to provide the mechanical arm 402 with the ability to perform specific tasks. For example, as discussed in more detail with reference to FIGS. 5A, 5B, 6A, and 6B, an EV charging port (and/or other components) and/or sensors can be integrated into or attached to an end link (e.g., extension member 408b) of a mechanical arm so that the mechanical arm can insert the charging port into the charging receptacle of the EV.

In FIG. 4A, the mechanical arm 402 is configured to route the charging cable 410 from the EV charging station 120 to an arm access port 412 of the mechanical arm 402. The arm access port 412 can be formed as a void in the surface of the extension member 408b through which the charging cord 410 passes to make the charging cord 410 accessible and maneuverable by a person connecting the charging port of the EV charging station 120 to the charging receptacle 414 of the EV 416. In some implementations, the arm access port 412 can be a connectorized port of the mechanical arm. That is, the arm access port 412 can have a connector to which a mating connector of the charging cord 410 can be connected. For example, depending on the geography and the charging level, the connector of the arm access port 412 can be selected from among the following types of connectors:
1. J1772 Connector: This is a Level 2 charging connector that is used in North America, and it provides up to 240V of power. It features a standard five-pin configuration and is compatible with most EVs on the market.
2. CCS Connector: This is a Combined Charging System connector that can support both Level 2 and DC fast charging. It features a two-pin DC charging connector that is located below the Level 2 charging connector. The CCS connector is commonly used in North America, Europe, and Asia.
3. CHAdeMO Connector: This is a Level 3 DC fast charging connector that is primarily used in Japan and Europe. It features a unique design that includes a large, circular connector with two small pins at the bottom.
4. Tesla Connector: This is a proprietary charging connector used exclusively by Tesla vehicles. It supports Level 2 and Level 3 DC fast charging and features a unique six-pin configuration.
5. Type 2 Connector: This is a European standard charging connector that supports both Level 2 and DC fast charging. It features a seven-pin configuration and is commonly used in Europe.
6. GB/T Connector: This is a Chinese national standard charging connector that supports both Level 2 and DC fast charging. It features a nine-pin configuration and is commonly used in China.

In these implementations, a segment of the charging cord 410 can have a corresponding connector that enables that segment of the charging cord 410 to be connected to the connector of the arm access port 412. To provide flexibility to charge EVs having different types of charging receptacles, the segment of the charging cord 410 can connect to the arm access port 412 using one type of connector, and have a different type of connector matching the connector of the EV charging receptacle 414 at the other end of the segment of the charging cord 410.

As shown in FIG. 4A, a source power cable 418 is routed from the EV charging station 120 to a base access port 420. Like the arm access port 412, the base access port 420 can be formed as a void in the surface of the base 406 through which the source power cable 418 passes. In these implementations, the source power cable 418 can simply be a section of the charging cord 410 that extends from the base access port 420 to the EV charging station 120. In other words, the charging cord 410 can connect to the EV charging station 120, be routed into the base access port 420, routed through a cord channel (e.g., a void) formed within the perimeter of the base 406 and the extension members 408a and 408b, and routed out of the mechanical arm 402 by way of the arm access port 412. In this configuration, the mechanical arm 402 operates as a housing for the charging cord 410, which prevents damage to the charging cord 410, and having the charging cord 410 exit the extension member 408b at the arm access port 412 elevates the charging cord 410 off of the ground so that it is easier to move, and does not pose a tripping hazard.

In some implementations, the base access port 420 can be a connectorized port of the mechanical arm 402 that is located in the base 406. In these implementations, the base access port 420 can have a connector to which a mating connector of the charging cord 410 can be connected, in a manner similar to that discussed above with reference to the connectorized implementation of the arm access port 412. When implemented using connectors, the mechanical arm 402 can be configured (e.g., fabricated) with conductors extending through the mechanical arm 402 from the base access port 420 to the arm access port 412, such that completing the electrical connection between the EV charging station 120 and the EV 416 is achieved by (i) connecting the source power cable 418 to each of the EV charging station 120 and the connector of the base access port 420, and (ii) connecting the charging cord 410 to each of the connector of the arm access port 412 and the charging receptacle 414 of the EV 416.

As shown in FIG. 4A, the base 406 of the mechanical arm 402 can be installed near the EV charging station (e.g., within 2-3 feet or closer), thereby reducing the length of the power source cable 418 that is exposed and/or laying on the ground. This implementation of the mechanical arm 402 can be used to modify existing EV charging station 120 installations so that the power source cable 418 and/or the charging cord 410 is less of a trip hazard than when the entirety of the existing charging cord 410 is laying on the ground.

The extension members 408a and 408b are pivotally and/or rotationally connected to each other and the base 406, such that the mechanical arm 402 is configured to adjust the dispensing location (e.g., the location of the arm access port 412) of the charging cord 410. As discussed in more detail below, the mechanical arm 402 can be configured to transition between a stowed state and an active state, and vice versa. Furthermore, the mechanical arm can be configured to adjust the dispensing location between the locations of charging receptacles on different EVs. For example, some EVs have the charging receptacle located at a front of the vehicle, and some EVs have the charging receptacle located at the back of the receptacle. Also, some people pull their EV in front-first to a charging station, and some people back their EV into a charging station, which can also change the location of the charging receptacle.

The mechanical arm 402 is configured to adjust the dispensing location between locations based on the location of the charging receptacle of the EV to be charged. For example, the extension members 408a and 408b can be configured to extend to different locations so that power can be dispensed to charging receptacles at different locations. More specifically, the pivotal and/or rotational connections of the extension members 408a and 408b enable the dispensing location (e.g., a location at which the charging port connects to the charging receptacle of the EV) to be adjusted to multiple different locations for multiple different cars, some of which will be closer to the EV charging station 120 and/or base 406, and some of which will be further away from the EV charging station 120 and/or base 406. FIG. 4A shows the mechanical arm 402 in an active state in which the extension members 408a and 408b are extended/unfolded in manner so as to adjust the dispensing location to the location of the charging receptacle 414. For example, a person can hold the charging port located at the end of the charging cord 410, and when the user moves the location of the charging port, the positions of the extension members 408a and 408b can adjust by way of the pivotal and/or rotational connections so that the person can maneuver the charging port to the location of the charging receptacle 414 on the EV 416.

FIG. 4B is illustration of the mechanical arm 402 in a stowed state. In the stowed state, the extension members 408a and 408b are in a retracted position, such that the charging cord 410 is closer to the base 406 than it was in the active state shown in FIG. 4A. More specifically, in this implementation, the mechanical arm 402 is configured such that the extension members 408a and 408b can be folded up in an accordion fashion. For example, the extension member 408a is pivotally/rotationally connected to the base 406 so that the extension member 408a can fold down (or up), which causes the full length (and/or distal end of the extension member 408a connected to the extension member 408b) of the extension member 408a to be closer to the base 406 than it was in the active state shown in FIG. 4A. Similarly, the extension member 408b is pivotally/rotationally connected to the extension member 408a, such that the extension member 410b can fold in closer to each of the extension member 408a and the base 406.

In some implementations, the stowing (e.g., folding or other retracting) of the extension members 408a and 408b can be performed manually. In some implementations, the stowing can be performed by hydraulics, a motor, or appropriate electronic mechanisms. For example, the transition from one state (e.g., active state) to another state (e.g., stowed state) can be initiated in response to the mechanical arm 402, or another component including control circuitry, such as one or more processors, detecting user interaction with a change state button. More specifically, interaction with a “close” button or “open” button can be detected, and in response, the movement (e.g., folding or unfolding) of the mechanical arm 402 can be initiated. Movement of the mechanical arm 402 can be halted when the mechanical arm 402 has completed a state change (e.g., the mechanical arm 402 reaches the active state or the stowed state).

The mechanical arm 402 can also be configured to include circuitry that detects when the charging port has been removed from the charging receptacle 414 of the EV 416, and initiate a transition to the stowed state in response to detecting that the charging port has been physically removed from the charging receptacle 414. For example, the mechanical arm can include an open circuit sensor that triggers a state change signal when an open circuit exists at the charging port. Additionally, or alternatively, the mechanical arm 402 can include a mechanical storage interface (not shown) that is configured to receive the charging port 422, and detect when the charging port 422 is inserted into the mechanical storage interface. When the charging port 422 is detected in the mechanical storage interface (e.g., by control circuitry), the state change signal can be generated. The state change signal can cause a motor to begin retracting and/or folding the mechanical arm 402 until it reaches the stowed state (e.g., as shown in FIG. 4B).

When the mechanical arm 402 reaches the stowed state, the arm access port 412 can be elevated relative to an opposite end of the extension member 408b, which reduces the amount of the charging cord 410 that may come in contact with the ground, and may prevent the charging cord 410 and charging port 422 from contacting the ground completely depending on the length of the charging cord 410 and the length of the extension member 408b. For example, a length of the extension member 408b can be selected so that the length of the charging cord 410 is equal to or shorter than the length of the extension member 408b. Similarly, the length of the extension member 408b can be selected so that the height of the arm access port 412 from the ground in the stowed state is greater than (or equal to) the length of the charging cord 410.

FIG. 4C is an illustration of another configuration of the mechanical arm 402 connected to the EV charging station 120. In this configuration, the base 406 of the mechanical arm 402 is located on an opposite side of the parking block 424 than the EV charging station 120. In this configuration, the base 406 of the mechanical arm 402 is closer to the charging receptacle 414 of the EV 416 than the EV charging station 120, which enables the charging cord 410 to reach the charging receptacle 414 without fully extending the extension members 408a and 408b. In this configuration, the mechanical arm 402 is positioned closer to a designated charging location for an EV (e.g., parking space denoting where an EV is to park for EV charging) than the EV charging station 120.

To reduce the amount of the source power cable 418 that is exposed on the ground, the source power cable 418 can be routed through the parking block 424. For example, the source power cable 418 can be routed through a cord channel in a manner similar to that discussed with respect to any of FIGS. 2A-2K. For instance, the source power cable 418 can enter the parking block through an entry port that is on a side of the parking block 424 facing the EV charging station 120 or on an end of the parking block 424. The source power cable 418 can then be routed through the cord channel defined in the parking block 424, and exit the parking block 424 through an exit port that is located on a side of the parking block 424 that faces the parking space for the EV 416 (e.g., an opposite side of the parking block 424 than the EV charging station 120), or an end of the parking block 424. As shown, the source power cable 418 exits the parking block 424 at the end of the parking block 424, but the source power cable 418 could exit the parking block 424 on the side facing the EV 416 (e.g., in a center ⅓ portion of a parking space for the EV 416), such that the source power cable 418 could be routed under the EV 416, and into the base 406 of the mechanical arm 402 from underneath the EV 416.

FIG. 4D shows the configuration of the mechanical arm 402 from FIG. 2C in an extended or active state. For example, the extension members 408a and 408b have been moved away from their resting positions in the stowed state, which need not be a completely retracted position, so that the charging cord 410 is closer to the charging receptacle 414, which is positioned at the back of the EV 426. In this example, the extension members 408a and 408b remain lower to the ground than the configuration shown in FIGS. 4A and 4B.

FIG. 4E shows a configuration of the mechanical arm 402 in which the base 406 is attached to, or part of, the EV charging station 120. In some implementations, the base 406 can be installed adjacent to (e.g., touching or within inches of) the EV charging station 120, thereby essentially eliminating any exposed portion of the source power cable 418 of FIG. 4D. In some implementations, the frame or another part of the EV charging station 120 operates as the base 406, such that the base 406 may not even be distinguishable from the frame of the EV charging station 120. For example, at one end, the extension member 408a can connect to a pivotal/rotational connection point of the EV charging station, and the other end of the extension member 408a can be connected to the extension member 408b. This configuration eliminates the exposed source power cord.

FIG. 4F is an illustration of the mechanical arm 402 with a cord dispenser 428 attached to the extension member 408b, which in this configuration is a folding portion of the mechanical arm 402. The cord dispenser 428 is configured to dispense and retract a portion of the charging cord 410. In some implementations, the cord dispenser 428 can include a spring retraction mechanism configured to retract the charging cord 410 when the spring is released (e.g., by way of a short pull on the charging cord 410). In some implementations, the cord dispenser 428 can include a motorized retraction mechanism that turns to retract/respool the charging cord 410.

A spring retraction mechanism is a device that uses a spring to retract or pull back a component to its original position after it has been moved or displaced. This mechanism is commonly used in various applications such as mechanical devices, automobiles, and electronics. The basic concept of a spring retraction mechanism is that a spring is attached to a component that can move or rotate, such as a lever or a pulley. When the component is moved or rotated, the spring is compressed, storing potential energy. When the force that moved the component is removed or reduced, the spring expands and releases the stored energy, which causes the component to move back to its original position. In this case, the spring will be compressed when the charging cord 410 is pulled out of the cord dispenser 428, and the spring is released (e.g., by way of a short tug that disengages a latch) the spring will retract the charging cord 410.

The base 406 is shown as being adjacent to the charging station 120, but the base 406 could be placed in other locations as discussed above. The configuration of FIG. 4F eliminates any exposed source power cords laying on the ground, and also prevents the charging cord 410 that extends from the cord dispenser 428 to the charging receptacle 414 from being in contact with the ground. The cord dispenser 428 can be attached to/used with any of the configurations of a mechanical arm discussed herein.

In some implementations, retraction of the charging cord 410 by the cord dispenser 428 can be prevented until charging of the EV 426 has completed. For example, the mechanical arm 402 (or control circuitry in communication with the mechanical arm) can be configured to detect when charging of the EV 426, and only enable the cord dispenser 428 to retract the charging cord 410 in response to determining that the charging is complete. More specifically, as discussed above, an open circuit sensor (or another sensor) can detect when the charging port is removed from the charging receptacle 414, such that retraction of the charging cord 410 by the cord dispenser 428 is only performed after the charging port has been removed from the charging receptacle 414. This can prevent damage to the charging port and/or charging cord 410 that could otherwise occur if retraction of the charging cord 410 were initiated prior to removal of the charging port from the charging receptacle 414.

FIG. 4G is an illustration of the mechanical arm 402 in the stowed state when the cord dispenser 428 is attached to the mechanical arm 402. In this illustration, the extension members 408a and 408b fold in a manner that positions the cord dispenser 428 at a height that is reachable by a person who wants to charge the EV 426. For example, as shown, the extension member 408a has retracted to a vertical position relative to its position in the active or extended state shown in FIG. 4F, and the connection point 430 between the extension member 408a and 408b is higher than when the extension members 408a and 408b were extended as shown in FIG. 4F. Meanwhile, the cord dispenser 428 is lower than the connection point 430, and the charging port 432 is exposed and available to be handled by a person wanting to charge the EV 426.

Of course, depending on the dimensions selected for the extension members 408a and 408b and/or the application, the extension members 408a and 408b could fold in a manner similar to that shown in FIG. 4B, which could also position the cord dispenser 428 at a height where the charging port 432 would be exposed and available to be handled by a person wanting to charge the EV 426. In that scenario, the connection point 430 would be lower than when the extension members were extended as shown in FIG. 4F, and the cord dispenser 430 and charging port 432 would be higher than the connection point 430.

The charging port 432 can include a metal clad “MC” high current connector that is designed to handle high current loads in power distribution applications. MC high current connectors are typically used to connect metal-clad cables, which consist of multiple conductors that are individually insulated and wrapped in a metallic sheath. These connectors provide a reliable and secure connection between the cable and other electrical equipment, such as an EV. MC high current connectors are typically designed to handle current loads ranging from a few hundred amps to several thousand amps, and are built to withstand harsh environments and heavy usage.

FIG. 4H is another illustration of the mechanical arm 402 in the stowed state when the cord dispenser 428 is attached to the mechanical arm 402. This illustration shows that the mechanical arm 402 can remain in the stowed state, and still be configured to allow the charging port to be connected to the charging receptacle 414 of the EV 426 using the cord dispenser 428. In this scenario, the cord dispenser 428 would dispense a sufficient amount of the charging cord 410 so that the charging port could be inserted into the charging receptacle 414 of the EV 426.

FIGS. 4I and 4J are illustrations of the mechanical arm 402 having a telescoping member 430, also referred to as a telescoping portion, attached. In FIG. 4I, the telescoping member 430 is shown in an extended (e.g., active) state that positions the charging cord 410 closer to (e.g., proximate to) the charging receptacle 414. In some implementations, the telescoping member 430 can be extended/deployed when requested by a user (e.g., by pushing a “start” button” or being authorized to begin charging the EV 426. For example, in response to the user being authorized to begin charging (e.g., by submitting charging account credentials), control circuitry that is part of, or in communication with, the mechanical arm 402 can extend the telescoping member 430 so that the cord dispenser 428 is located over (e.g., within a specified distance of) the location of the charging receptacle 414, which is located in the back section of the EV 426. As part of adjusting the location of the cord dispenser 428 to the location over the charging receptacle 414, one or both of the extension members 408a and 408b can be extended as well. For example, the extension members 408a and 408b can be moved (e.g., unfolded) from their stowed state, discussed with reference to FIG. 4B, to an active state in which the extension members 408a and 408b are moved into a more extended, rather than folded, orientation.

In some implementations, the mechanical arm 402 is configured to adjust the location of the cord dispenser 428 based on characteristics of the EV 426, and moving the mechanical arm to a specified position based on the characteristics of the EV 426. For example, control circuitry included in, or in communication with, the mechanical arm 402 can identify/obtain characteristics of the EV 426, such as, information indicating a vehicle type of the EV 426 and/or other characteristics of the EV 426. The information can be obtained, for example, through user input to a user interface of the EV charging station 120 (or the mechanical arm 402). For example, when the user arrives at the EV charging station 120, the user can input a make/model/model year of the EV 426. Similarly, when the user arrives, a camera can be used in combination with image recognition models to determine the make/model/year of the EV 426.

Additionally, or alternatively, the information can be obtained through communications with the EV 426, a mobile application on the user's mobile device, or another manner of communications. For example, the EV 426 can be equipped with wireless communication equipment that can interface with the EV charging station 120 (or other electronics) when the EV 426 arrives at the EV charging station 120 (e.g., enters the communication range of the charging station 120. In a specific example, the EV charging station 120 can be equipped with a wireless communication device 432 that can broadcast its identity to nearby devices. In this example, the nearby devices (e.g., EV 426 or a mobile device running a specified app) can detect the broadcast message when the devices enter a given physical area, identify the EV charging station's capabilities, and transmit information about the EV 426 to the EV charging station 120.

In some implementations, control circuitry can perform a database search using the received information to identify a location of the charging receptacle 414 on the EV 426, electrical charging parameters of the EV 426, or other information that can be used to customize the charging experience for the user. Of course, the information could be directly provided by the EV 426 in some situations.

In response to obtaining the information about the EV 426, the EV charging station 120 can adjust charging parameters to match the charging needs of the EV 426 and/or move the mechanical arm 402 into a specified position so that the dispensing location of the charging cord (e.g., where the charging cord exits the mechanical arm 402 and/or the location of the charging port) is closer to (e.g., within a specified distance of) the charging receptacle of the EV 426. For example, assume that the control circuitry determines that the charging 414 receptacle of the EV 426 is located in a back, driver's side, portion of the EV 426. In this example, the control circuitry can cause the mechanical arm 402 to position the cord dispenser 428 over (or otherwise within a specified distance of) the location of the charging receptacle 414 of the EV 426. Additionally, the control circuitry can cause the cord dispenser 428 to dispense a specified amount of the charging cord 410 so that the user can grab the charging cord 410 and insert the charging cord 410 into the charging receptacle 414 of the EV 426.

In another example, as shown in FIG. 4J, assume that the control circuitry determines, based on the obtained information, that the charging 414 receptacle of the EV 416 is located in a front, driver's side, portion of the EV 416. In this example, the control circuitry can cause the mechanical arm 402 to position the cord dispenser 428 over (or otherwise within a specified distance of) the location of the charging receptacle 414 of the EV 416. Additionally, the control circuitry can cause the cord dispenser 428 to dispense a specified amount of the charging cord 410 so that the user can grab the charging cord 410 and insert the charging cord 410 into the charging receptacle 414 of the EV 416.

In this example, the adjustment of the dispensing location of the charging cord 410 can be accomplished by moving the cord dispenser 420 to a target location that is over (or within a specified horizontal distance of) the location of the charging receptacle 414 of the EV 416. For example, the control circuitry can extend (or retract) the telescoping member 430 until the cord dispenser 428 is at the target location. As needed, the control circuitry can also adjust the locations of one or more of the extension member 408a and/or the extension member 408b to position the cord dispenser 428 (or arm access port 412 of FIG. 4A) at the target location. In some implementations, the target location can be a set of coordinates (e.g., x, y, z) that is specified based, at least in part, on the characteristics of the vehicle to be charged. The characteristics can include one or more of a location of the charging receptacle 414 on the vehicle, orientation of the vehicle in a parking spot, physical dimensions of the vehicle (e.g., so the mechanical arm avoids the vehicle). Using these characteristics, the control circuitry can select the coordinates of the target location, as well as a movement path that will enable the target location to be reached without colliding with the vehicle or any other objects.

The characteristics can also include user preferences of a driver of the vehicle. For example, the characteristics can include a desired height of the charging port when the cord dispenser 428 (or arm access port 412) has reached the target location. In a specific example, assume that the driver is 5′1″ tall, and prefers the charging port to be made available at 5′3″ above the ground when the target location near the charging receptacle 414 is reached. In this example, the control circuitry can adjust one or more of the extension member 408a, the extension member 408b, and/or the telescoping member 428 to place the cord dispenser 428 at the target location. In some situations, the adjustment of the various members can result in the charging port being at the desired height (e.g., 5′3″ in this case), but in other situations, placing the charging port at the desired height may also require dispensing or retracting a portion of the charging cord 410 until the charging port reaches the desired height.

FIG. 4K is an illustration of the mechanical arm 402 having the telescoping member 430 in the stowed state. As shown, the mechanical arm 402 has been stowed in a vertical orientation. This orientation can be achieved, for example, by the control circuitry causing the extension member 408a to fold/pivot/retract to a vertical position, the extension member 408b (not visible) to fold/pivot/retract into a similar vertical position, and the telescoping member 430 to similarly fold/pivot/retract into a similar vertical position. Additionally, the control circuitry has caused the telescoping member 430 to retract telescoping portions into an outer shell of the portion of the telescoping member 430 that is visible in FIG. 4K. In this orientation, the cord dispenser 428 is elevated out of reach, which can make tampering with the charging port 432 more difficult, thereby preventing potential damage to the charging port 432. Of course, any of the stowed configurations could be used to stow the mechanical arm 402 depicted by FIG. 4K.

FIG. 5A is an illustration of a mechanical arm 502 connected to a mobile base 504. As shown, the mobile base 504 is attached to a track 506. In some implementations, the mobile base 504 can be configured to move along the track 506. For example, the mobile base 504 can be attached to a pully/conveyor system within the track 506. Alternatively, or additionally, the mobile base 504 can have wheels that can move the mobile base 504 back and forth relative to the EV charging station 120 and/or a length of a parking spot for the EV 510, while the track 506 keeps the mobile base 504 on a designated travel path. In other words, the mobile base can move toward and away from the charging station 120, which is providing power to the charging cord. In some implementations, a portion of the charging cord (e.g., the source power cable) can be housed in the track, or otherwise situated at a position near the track, to conceal that portion of the charging cord that extends between the EV charging station 120.

In this example, the mechanical arm 502 is a telescoping arm similar to the telescoping member 430 discussed above. In operation, the telescoping arm can extend and retract to adjust the dispensing location in a manner similar to that discussed above. A charging port 508 is attached to the end of the mechanical arm 502. As discussed above and in more detail below, the charging port 508 can be inserted into the charging receptacle 512 of the EV 510 to charge the EV 510.

The mechanical arm 502 is configured to move up and down the mobile base 504 (e.g., vertically) to adjust the height of the charging port 508 based on the height of the charging receptacle 512 of the EV 510 to be charged. For example, when the EV 510 arrives at the parking area (e.g., parking space) for the EV charging station 120, the mechanical arm 502 can be adjusted vertically on the mobile base 504. Similarly, when a different EV arrives at the parking area for the EV charging station 120, the mechanical arm can be adjusted to a different vertical height based on the height of the charging receptacle of the different EV.

The vertical movement of the mechanical arm 502 can be performed manually or can be automated using motors. For example, the mobile base 504 can have an arm adjustment channel 514 defined therein, which can enable the mechanical arm 502 to be moved up and down the vertical height of the mobile base 504. In some implementations, the mechanical arm 502 can be attached to a pully/conveyor system that moves the mechanical arm 502 up and down the arm adjustment channel 514. Of course, other appropriate mechanisms can be used to move the mechanical arm 502 along the arm adjustment channel 514. Similarly, the movement of the mechanical arm 502 up and down the mobile base 504 can be facilitated using other guiding mechanisms other than the arm adjustment channel 514. For example, the mechanical arm 502 can be configured to encase the perimeter of the mobile base 504, and have wheels or other mechanisms that are in contact with the mobile base 504, and facilitate the vertical movement on the mobile base 504. Additionally, or alternatively, the mobile base 504 can have telescoping capability that is used to adjust the vertical height of the mechanical arm 502. For example, the mechanical arm 502 can remain affixed to a specific location on the mobile base 504, and the mobile base 504 can vertically extend and retract to adjust the height of the mechanical arm 502.

In some implementations, the height adjustment can be performed based on the characteristics of the EV 510 obtained by control circuitry and discussed above. For example, when the EV 510 enters the parking area of the EV charging station 120, communications between the EV charging station 120 (or other electronics) and the EV 510 (or a mobile application executing on a mobile device) can provide the EV charging station 120 with make/model/year information about the EV 510. Using this information control circuitry can determine the coordinates (e.g., x, y, z) to which the mechanical arm 502 needs to be moved based on the known location of the charging receptacle 512 of the EV 510. Using these coordinates, the control circuitry can adjust the height of the mechanical arm 502 to the appropriate height based on the characteristics of the EV 510. Additionally, the control circuitry can use the coordinates to move the mobile base 504 to a target location based on the location of the charging receptacle 512 of the EV 510.

For example, as shown in FIG. 5B, the mobile base 504 has moved down the track 506 toward the rear of the EV 510, and the height of the mechanical arm 502 has been adjusted to a lower height so that the charging port 508 is at the height of the charging receptacle 512 of the EV 510. Additionally, the charging port 508 has been inserted into the charging receptacle 512 of the EV 510.

In some implementations, the insertion of the charging port 508 into the charging receptacle 512 can be performed manually. For example, the positions of the mobile base 504 and mechanical arm 502 can be adjusted to a target location (e.g., based on the characteristics of the EV 510 and/or determined coordinates), and then a user can manually insert the charging port 508 into the charging receptacle 512 of the EV 510.

In some implementations, the insertion of the charging port 508 into the charging receptacle 512 can be automated, such that control circuitry can cause the insertion. In these implementations, various data can be collected to facilitate movement of the charging port 508 to the appropriate location and ensuring that the charging port 508 is properly aligned with the charging receptacle 512 before moving the charging port 508 to make the connection with the charging receptacle 512.

A receptacle detection apparatus can be used to detect the location of the charging receptacle 512 before insertion of the charging port 508 into the charging receptacle 512. The receptacle detection apparatus can include one or more processors and one or more sensors that are attached to the mechanical arm 502, or otherwise positioned to be capable of detecting the charging receptacle 512. For example, the sensors can be light detecting and ranging (LIDAR) sensors, cameras, or other sensors that can capture visual and/or positional data of objects.

The data captured using the sensors can be processed by the one or more processors, which can be part of the control circuitry discussed throughout this specification, to identify the location of the charging receptacle 512. For example, computer vision techniques and/or machine learning models can be used to determine the likelihood that a set of data collected by the sensors is a charging port. When the likelihood is higher than a specified threshold, the object represented by the set of data can be classified as the charging port, and the location (e.g., x, y, z coordinates) of the charging port can be determined.

Once the coordinates are determined, the control circuitry can initiate movement of the mobile base 504 and mechanical arm 502 into position to align the physical location of the charging port 508 with the determined physical location charging receptacle 512. For example, the ability to align the physical location of the charging port 508 with a detected location of the charging receptacle 512 enables alignment with charging receptacles that are at different locations on different vehicles, or at different locations because of the orientation of the EV 510 relative the mechanical arm 502.

Insertion of the charging port 508 can proceed, for example, with the mechanical arm 502 telescoping (e.g., extending) toward the EV 510. As the mechanical arm 502 telescopes toward the EV 510, the sensors of the receptacle detection apparatus can continue to collect data to monitor the location of the charging port 508 relative to the charging receptacle 512. If the data collected by the sensors indicates that the charging port 508 is no longer properly aligned, the control circuitry can determine the adjustments that need to be made, and the insertion of the charging port 508 into the charging receptacle 512 can continue until an electrical connection is made between the charging port 508 and the charging receptacle 512, as shown in FIG. 5B.

Once the charging port 508 is electrically connected to the charging receptacle 512, the charging station 120 can initiate charging of the EV 510. For example, the charging station 120 can deliver AC or DC energy to the EV 510 through the charging port 508 and charging receptacle. The control circuitry can then monitor the charge state of the EV 510, and move the mechanical arm to a designated location based on the charge state of the EV 510 reaching a charge complete state. In some implementations, control circuitry can detect when charging is complete, and retract the charging port from the charging receptacle after the charging is complete. For example, while the charging port is still connected to the charging receptacle 512, the control circuitry can use a voltage and/or current sensor to determine when the voltage and/or current flowing to the EV 510 has dropped to a specified level indicating that the EV 510 is sufficiently (e.g., fully) charged and the charge cycle is complete.

Additionally, or alternatively, the control circuitry can detect when the charging port 508 has been physically removed from the charging receptacle 512, and begin to retract the charging port 508 when the charging port 508 has been physically removed from the charging receptacle 512. When the mechanical arm 502 has a telescoping portion, the telescoping portion can be retracted to shorten the length of the mechanical arm 502, thereby retracting the charging port 508. When the mechanical arm has a folding portion (e.g., as shown in FIG. 4H) the charging port and/or charging cord can be retracted by retracting (e.g., folding in) the folding portion of the mechanical arm.

FIGS. 6A and 6B are illustrations of a mechanical arm 602 connected to an elevated base 604. The elevated base 604 is shown as secured to a ceiling 606 of a structure. The elevated base 604 can be secured to the ceiling 606 using bolts, adhesive, or other materials capable of adequately securing the elevated based 604 to the ceiling 606. In some implementations, the elevated base can be an I-beam, or another structure that has a channel, groove, track, or other feature that enables the mechanical arm 602 to traverse the length of the elevated base 604, and align the charging port 610 with the charging receptacle 612 of the EV 614.

Although the mechanical arm 602 is attached to the elevated base 604, the mechanical arm 602 can be configured to automatically align the charging port 610 with the charging receptacle 612, and perform the functions discussed above with reference to other mechanical arm configurations. For example, FIG. 6B shows the mechanical arm 602 in an extended, or active, state in which the mechanical arm 602 has been moved (e.g., by the control circuitry) away from the wall 616 to align the charging port 610 with the charging receptacle 612 of the EV 614, and insert the charging port 610 into the charging receptacle 612. In some implementations, the operation of the mechanical arm 602 and the charging functionality can be completely automated so that the driver of the EV 614 doesn't need to exit the EV 614 to complete the charging.

In some implementations, some or all of the components of the EV charging station 120 and/or other components (e.g., circuitry and/or logic) can be incorporated into other structures. For example, components 618 (e.g., of the EV charging station 120) can be incorporated into the parking block 620, the mechanical arm 602, or a combination of both, as shown in FIG. 6A. For example, the components 618 can include one or more of a high frequency transformer configured to convert the AC power from the grid to AC power or DC power that is suitable for charging the EV's battery.

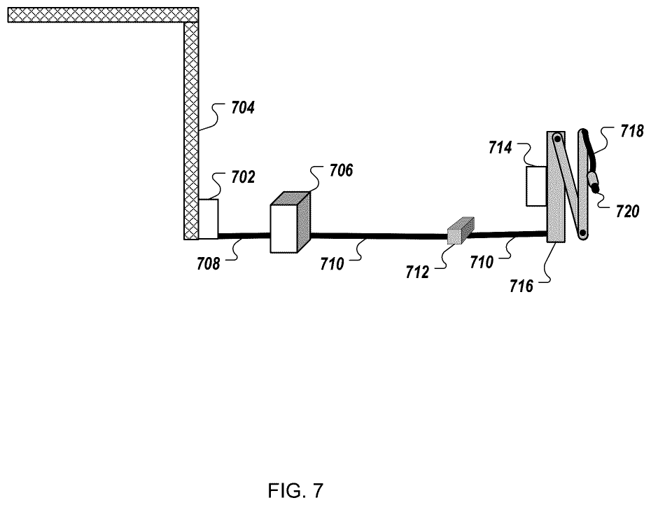

For example, as discussed below with reference to FIG. 7, rather than receiving power from the EV charging station 120, which outputs the power that is conditioned as needed to charge the EV 614, the components 618 can be configured to receive low-frequency AC power (e.g., from a standard 50-60 Hz plug that provides power from a public utility), or the components 618 can be configured to receive high frequency AC power. This high-frequency AC power can be down converted (e.g., using a step-down transformer) and/or input to an AC/DC converter, which can also be included in the components 618 incorporated into the parking block 620 and/or the mechanical arm 602. The AC/DC converter is configured to convert the AC power to DC power to charge the battery of the EV 614.

Incorporation of the components 618 into the parking block 620 or mechanical arm 602 can reduce the size of the EV charging station 120 or eliminate the need for the EV charging station 120. For example, a portion of the components 618 incorporated into the parking block 620 can be configured to receive high frequency AC power (e.g., from a step-up transformer at the EV charging station 120). In this example, the components 618 incorporated into the parking block 620 can include one or more of a step-down transformer configured to convert the high frequency AC power to low frequency AC power and/or an AC-DC converter (e.g., a rectifier) configured to convert AC power to DC power that is made available at the charging port 610.

In some implementations, the components 618 of the parking block 620 can be configured to plug into a standard low frequency AC power source, such as a receptacle that provides 50-60 Hz power from a public utility. In this example, the portion of the components 618 incorporated into the parking block 620 can include a step-up transformer configured to convert the low frequency AC power to high frequency AC power that is then passed to a second portion of the components 618 that are housed at the mechanical arm 602. The second portion of the components 618 can include one or more of a step-down transformer configured to convert the high frequency AC power to low frequency AC power and/or an AC-DC converter (e.g., a rectifier) configured to convert AC power to DC power that is made available at the charging port 610.

In some implementations, all of the components 618 of the EV charging station 120 can be incorporated into parking blocks 620 and/or a housing of the mechanical arm 602, such that the housing of the EV charging station 120 would not be needed. Rather, the parking blocks 620 and/or mechanical arm 602 would be configured to connect directly to the AC power of the grid, and convert/condition that AC power as needed to charge the EV 614. For example, the parking block 620 and/or mechanical arm 602 can include one or more transformers, one or more inverters, and control circuitry including one or more processors, to properly condition input power for charging the EV 614 and/or managing the power delivered to the EV 614 during the charging process. These components 618 can also be incorporated into any of the parking blocks or mechanical arms discussed throughout this specification.

In some implementations, the input power can be obtained from one or more solar panels 622 that are electrically connected by conductor 624 to the EV charging station 120, the parking block 620, and/or the mechanical arm 602. For example, the solar panels 622 can collect solar energy and convert the solar energy to DC power, which can either be conditioned and transferred to the battery of the EV 614 in a DC charging implementation, or the DC power can be converted to AC power, which is then conditioned in a manner similar to AC power obtained from the grid (e.g., using the components 618 discussed above).

When some, or all, of the components 618 of the EV charging station 120 are incorporated into the parking block 620 and/or the mechanical arm 602, the parking block 620 or the mechanical arm 602 can be connectorized to provide input power to the components 618. For example, power cord connector can be installed in the exterior (e.g., frame) of the parking block 620 or mechanical arm 602 to enable the parking block or mechanical arm 602 to be plugged into a power outlet from the electrical grid. Additionally, or alternatively, the parking block 620 and/or mechanical arm 602 can have other connectors, such as the MC high current connectors discussed above, installed in the exterior of the parking block 620 or the mechanical arm 602. Configuring these objects with standard electrical connectors enables plug and play capability for these objects. The other parking blocks and mechanical arms discussed throughout this specification can similarly be configured to include some, or all, of the components 618 of the EV charging station 120.

The parking block 620 and/or mechanical arm 602 can also be configured with automation components that facilitate an automated charging experience. For example, the parking block 620 and/or mechanical arm 602 can include wireless communications components, similar to those discussed with reference to FIGS. 4I and 4J, which can communicate with one or more of the EV 614, a mobile device of a user, or another device when the EV 614 arrives at a location of the parking block 620 and/or mechanical arm 602. This communication can include an automatic transfer of information about the EV 614 to control circuitry that enables the operations discussed throughout this specification. In this way, when a driver of the EV 614 arrives at the parking block 620 or mechanical arm 602, and the control circuitry will determine the appropriate charging settings, detect the location of the charging receptacle 612, align the charging port 610 with the charging receptacle 612, insert the charging port 610 into the charging receptacle 612, initiate charging of the EV 614, monitor the charging state of the EV 614, determine when a charge complete state is reached, remove the charging port 610 from the charging receptacle, and return the charging arm 602 to a stowed state, all without human intervention.

FIG. 7 is an illustration of a configuration in which high frequency Alternating Current (“AC”) power used to facilitate EV charging. In this configuration, low frequency AC power is provided by a power source 702. The power source 702 can be, for example, a power outlet that is located on a wall 704, and electrically connected to the grid (e.g., public power utility) or another power distribution system. The low frequency AC power provided by the power source can be, for example, 50-60 Hz (Hertz) AC power.

As used in this document, low frequency AC power includes AC power that is at, or below, 100 Hz. In some implementations, all AC power greater than 100 Hz is considered high frequency. In some implementations, AC power greater than one of 200 Hz, 300 Hz, or 400 Hz is considered high frequency AC power. In some implementations AC power greater than 1000 HZ is considered high frequency. In any of these implementations, the AC power between 100 Hz and the minimum frequency considered high frequency can be referred to as mid-frequency AC power. For example, assume that the minimum frequency used to delineate high frequency from non-high frequency AC power is set to 1000 Hz. In this example, AC power having a frequency between 100 Hz and 1000 Hz could be referred to as mid-frequency AC power.

As illustrated, a step-up transformer 706 is electrically connected to the power source 702 by a source conductor 708. The step-up transformer 706 is a transformer that increases the frequency of an input AC signal (e.g., the low frequency AC power provided by the power source 702). The source conductor 708 can be a standard power cord since the source conductor 708 is delivering low frequency AC power to the step-up transformer 706.

A step-up transformer is used in applications where the input AC voltage is to be increased to a higher voltage level with a corresponding decrease in current. This is achieved by winding the secondary coil with more turns than the primary coil, which results in a higher voltage output. In the context of AC signals, a step-up transformer can be used to increase the frequency of the input signal by passing it through a circuit that includes a series of capacitors and inductors, known as an LC circuit. The LC circuit resonates at a specific frequency, effectively boosting the amplitude of the input signal and increasing its frequency.

In the present configuration, the low voltage AC being input to the step-up transformer 706 is being converted to high frequency AC power (e.g., greater than 100 Hz, 200 Hz, 300 Hz, 400 Hz, or 1000 Hz) that is then output over a high frequency conductor 710. The high frequency conductor 710 can have smaller dimensions than the source conductor 708 because the current level of the high frequency AC power output from the step-up transformer 706 will be lower than the current level of the low frequency power input to the step-up transformer 706. As such, the high frequency conductor 710 will pose less of a trip hazard than the source conductor 708 when laying on, or secured to, the ground. For example, the high frequency conductor 710 could be implemented as a ribbon cable (or another flat cable) similar to those previously discussed.

As shown, the high frequency conductor 710 is routed through a parking block 712. The high frequency conductor 710 can be routed through the parking block 712 in any manner previously discussed, for example, with reference to FIGS. 2A-2K and/or FIGS. 3A-3D. For purposes of this discussion, assume that the high frequency conductor 710 is routed through the parking block 712 in the manner discussed with reference to FIG. 2E, and exits the parking block 712 in a middle ⅓ section of the parking block 712.

The high frequency conductor 710 is then routed to a step-down transformer 714 that is attached to a mechanical (e.g., articulating) arm 716. The routing of the high frequency conductor 710 can be performed in many ways. For example, any of the charging cord routing techniques discussed throughout this document can be used. In a specific example, the high frequency conductor 710 can be routed in a manner similar to that shown in FIG. 2E, such that the high frequency conductor 710 is routed down a middle section (e.g., middle ⅓) of a parking space designated for EV charging, and then routed to a side of the parking space to the mechanical arm 716, which can be situated next to a designated parking area for an EV.

The step-down transformer 714 decreases the voltage of the high frequency AC power that is input to the step-down transformer 714 by way of the high frequency conductor 710. This is achieved by winding the secondary coil with fewer turns than the primary coil, which results in a lower voltage output. A step-down transformer is commonly used in applications where the input voltage is to be reduced to a lower level with a corresponding increase in current.

In the present configuration, the step-down transformer 714 can convert the high frequency AC power to low frequency AC power and/or be paired with a rectifier (or other circuitry) to ultimately convert the high frequency AC power to DC. When the step down transformer is not paired with additional circuitry to convert the high frequency AC power to DC, the output of the step-down transformer 714 can be low frequency AC power (e.g., at or below 100 Hz) that can be used to charge EVs that accept low frequency power as an input (e.g., to onboard chargers, which convert the low frequency AC power to DC).

When the step-down transformer 714 is paired with a rectifier (or other circuitry) the rectifier converts the AC power to DC power by allowing only the positive or negative portion of the AC waveform to pass through. A rectifier circuit typically consists of a series of diodes that are connected in a specific configuration to allow current to flow in only one direction, thereby providing a DC power output.

In some implementations, the step-down transformer could potentially be omitted by directly converting the high frequency AC power to DC power using a high frequency rectifier (or other circuitry) that is configured to perform the desired conversion. In these implementations, the diodes used to implement the rectifier would be chosen to have a high switching speed to handle the rapid changes in the input AC signal. In the discussion that follows, the phrase “conditioning circuitry” refers to the circuitry used to convert the high frequency AC power to achieve a target output power (e.g., low frequency AC or DC power).

The output of the conditioning circuitry (e.g., step-down transformer 714 and/or rectifier) is delivered to a charging cord 718 where it is made available to input to an EV by way of a charging port 720.

The configuration discussed with reference to FIG. 7 has the ability to eliminate the large charging station used in traditional charging stations. For example, by converting the standard grid power from low frequency AC to high frequency AC at a location near the power source, and then converting the high frequency AC power to low frequency AC power, or DC power, at a location closer to the EV (e.g., at the mechanical arm 716), the size of the components can be reduced relative to the size of components required to deliver the power to the same location using only low frequency AC power. For instance, the components needed to condition 60 Hz AC power for EV charging are orders of magnitude larger than components (e.g., a 1 kHz transformer) used to convert/condition the high frequency AC power. This reduces trip hazards, and increases the number of locations at which charging stations can be installed. It should be noted that instead of mounting the step-down transformer 714 and/or other circuitry to the mechanical arm 716, those components could be housed in the parking block 712, for example, as discussed above with reference to FIGS. 6A and 6B.

As discussed with reference to FIGS. 6A and 6B, one or more of the components/circuitry discussed with reference to FIG. 7 can be incorporated into the parking block 712 and/or a housing at the mechanical arm 716. For example, the parking block 712 can be a housing for the step-up transformer 706 or the step-down transformer 714. Additionally, or alternatively, the parking block can be configured to include other circuitry, such as an inverter, rectifier, transformer, or other circuitry configured to condition power input to the parking block for delivery to other circuitry housed at the mechanical arm 716, or for delivery to an EV by way of the charging port 720.

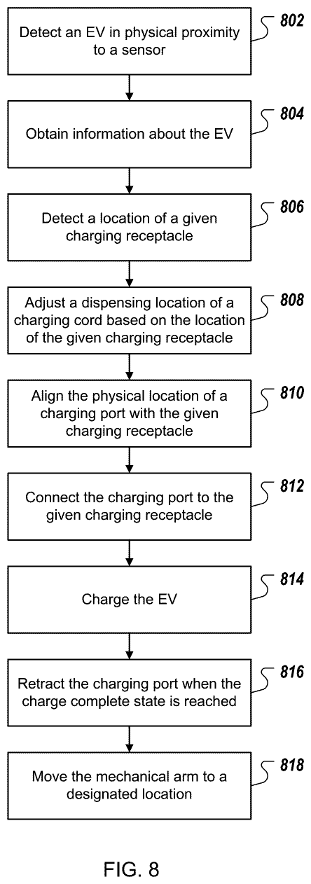

FIG. 8 is a flow chart of an example process 800 for controlling a mechanical arm. Operations of the process 800 can be performed, for example, by the control circuitry discussed herein. In some implementations, the control circuitry includes a memory device and one or more processors configured (e.g., specially programmed) to perform operations of the process 800. In some implementations, operations of the process 800 can be implemented as instructions stored on at least one non-transitory computer readable medium, and execution of the instructions cause one or more processors to perform operations of the process 800.

An EV is detected in physical proximity to a sensor (802). The EV can be detected, for example, by a communication sensor of an EV charging station. For example, the EV can be equipped with a wireless communication device that is detectable by the communication sensor of the EV charging station. When the EV is in range of the communication sensor, the EV charging station can detect the presence of the EV. The wireless communication device and the communication sensor can be configured to communicate using different wireless standards. For example, the communications can be performed using Bluetooth, cellular communications (e.g., 3G, 4G, or 5G), infrared communications, or near field communication. Alternatively, or additionally, the physical proximity of the EV can be detected using cameras, radar, LIDAR, pressure sensors installed in the pavement, or other appropriate sensors.

Information about the EV is obtained (804). The information about the EV can include one or more of a make/model/model year of the EV, charging parameters for the EV, charging modes the EV is capable of using, a location of the charging receptacle on the EV, an orientation of the EV, account information, or other appropriate information that can be used to facilitate charging of the EV. In some implementations, the information about the EV can be obtained from communications of the EV with the communication sensor (e.g., wireless receiver). For example, the communications sensor of the EV charging station can establish communications with the EV and obtain the information from the EV. In some implementations, the information about the EV can be obtained by a user's mobile device executing an application that interfaces with the EV charging station. The information about the EV can be used, for example, to adjust charging parameters of the charging station based on the characteristics of the EV.

A location of a given charging receptacle is detected (806). In some implementations, the location of the given charging receptacle is detected (or otherwise determined) using at least some of the obtained information about the EV. For example, the make/model/model year of the EV can be used to determine the physical location of the charging receptacle on the EV. Similarly, physical orientation information about the EV (e.g., front-first or rear-first orientation in the parking space) can be used to determine the location of the charging receptacle given the current parking orientation of the EV.

The location of the charging receptacle can also be detected using information collected using a receptacle detection apparatus having one or more processors and one or more sensors, such as a camera, radar, LIDAR, or another appropriate sensor. For example, when a location of the charging receptacle is known based on the obtained information about the EV, a camera or LIDAR can be used to scan the area where the charging receptacle should be located, collect data using the one or more sensors, analyze the data (e.g., using computer vision/object recognition techniques) using the one or more processors, and detect the actual location of the charging receptacle based on the analysis.

Even when information about the EV is not available, the location of the charging receptacle can be detected using the processors and sensors. For example, when a first EV arrives at the charging station, the location of the charging receptacle for that EV can be detected by scanning the entire EV (if needed), and using object detection to identify the location of the charging receptacle. Similarly, when a different EV arrives at the charging station, the location of the charging receptacle may differ from the location detected on the first EV. However, portions of the different EV can continue to be scanned and analyzed until the different location of the charging receptacle is detected.

A dispensing location of a charging cord is adjusted based on the location of the given charging receptacle (808). The dispensing location of the charging cord is a location at which the charging cord is made available to charge an EV. For example, the dispensing location can be a location at which the charging cord exits a mechanical arm and/or the location where the charging port is connected to the charging cord.

The dispensing location of the charging cord can be adjusted in a number of ways, as discussed throughout this specification. For example, the dispensing location can be adjusted by moving a mechanical arm toward a power source configured to provide power to the charging cord or moving the mechanical arm away from the power source configured to provide power to the charging cord. As discussed throughout this document, the movement of the mechanical arm can include movement by a mobile base, folding/unfolding sections of the mechanical arm, or extending/retracting telescoping portions of the mechanical arm. For example, control circuitry can generate electrical signals that cause movement of the mobile base and/or motorized components of the mechanical arm.

The dispensing location of the charging cord is generally adjustable to various different locations so that the mechanical arm can make the charging cord available for charging a variety of different EVs. Adjusting the dispensing location of the charging cord can include moving the mechanical arm to a specified position based on the characteristics of the EV. For example, when a first EV arrives at an EV charging station, the location of that EV's charging receptacle can be detected at a given location, and the dispensing location of the charging cord can be adjusted, using the mechanical arm, to a location that is near the given location of the charging receptacle to facilitate charging of that first EV. When a different EV arrives at the charging station, the location of the different EV's charging receptacle can be detected at a different location that is further from the power source of the EV charging station than the first EV. In this situation, the dispensing location of the charging cord can be moved further away from the power source so that the charging cord is more proximate to the different charging receptacle of the different EV. As such, the dispensing location of the charging cord is capable of being moved toward the power source and away from the power source to move the dispensing location to different locations based on the locations of the charging receptacles of the EVs.

As discussed with reference to FIGS. 5A and 5B, the dispensing location of the charging cord can also be adjusted vertically. For example, the mechanical arm can be attached to a mobile base and configured to move up and down the mobile base. The height of the dispensing location can be adjusted, for example, based on the height of the charging receptacle of the EV to be charged. Continuing with the example above, assume that the given location of the charging receptacle of the first EV is higher than the different location of the charging receptacle of the different EV. As such, the dispensing location of the charging cord can be adjusted to a higher location for the first EV based on the given location, and can be adjusted to a lower location for the different EV based on the different location being lower than the given location. In other words, the mechanical arm can move up the base when the first EV is to be charged, and move down the base when the different EV is to be charged.

A physical location of a charging port of a charging station is aligned with the given charging receptacle (810). In some implementations, the alignment is performed based on the detected given location of the charging receptacle. For example, the alignment can be based on the location of the first charging receptacle or a different location of a different charging receptacle of a different EV. As discussed above, the alignment of the charging port and the charging receptacle can be performed by identifying the location of the charging receptacle, determining coordinates that will align the charging port with the charging receptacle, and then moving one or more components of the mechanical arm, and/or a mobile base, to place the charging port at the determined coordinates.

The charging port is connected to the given charging receptacle (812). Insertion of the charging port be performed, for example, by a mechanical arm telescoping (e.g., extending) toward the charging receptacle of the EV. As the mechanical arm telescopes toward the EV, the sensors of the receptacle detection apparatus can continue to collect data to monitor the location of the charging port relative to the charging receptacle. If the data collected by the sensors indicates that the charging port is no longer properly aligned, the control circuitry can determine the adjustments that need to be made, and the insertion of the charging port into the charging receptacle can continue until an electrical connection is made between the charging port and the charging receptacle.

The EV is charged (814). Once the charging port is electrically connected to the charging receptacle, charging of the EV is initiated. For example, the charging station can deliver AC or DC energy to the EV through the charging port and charging receptacle. The control circuitry can monitor the charge state of the EV, and determine/detect when a charge complete state is reached indicating that charging is complete.

In some implementations, control circuitry can detect when charging is complete. For example, while the charging port is still connected to the charging receptacle 512, the control circuitry can use a voltage and/or current sensor to determine when the voltage and/or current flowing to the EV has dropped to a specified level indicating that the EV is sufficiently (e.g., fully) charged and the charge cycle is complete. Additionally, or alternatively, the control circuitry can detect when the charging port has been physically removed from the charging receptacle, indicating that charging is complete. For example, the control circuitry can include an open circuit sensor that is triggered when the charging port is physically removed from the charging receptacle.

The charging port is retracted when the charge complete state is reached (816). In some implementations, control circuitry can detect when charging is complete, and retract the charging port from the charging receptacle after the charging is complete. In some implementations, the control circuitry can begin to retract the charging port when the charging port has been physically removed from the charging receptacle.

Retracting, by a retraction mechanism, the charging port can include one or more of (i) re-spooling a section of the charging cord or (ii) retracting a portion of a telescoping portion or folding portion of the mechanical arm. In some implementations, the retraction mechanism can be part of a cord dispenser that is attached to the telescoping portion or the folding portion of the mechanical arm. The cord dispenser is generally configured to dispense and retract a portion of the charging cord.

When the mechanical arm has a telescoping portion, the telescoping portion can be retracted to shorten the length of the mechanical arm, thereby retracting the charging port. When the mechanical arm has a folding portion (e.g., as shown in FIG. 4H) the charging port and/or charging cord can be retracted by retracting (e.g., folding in) the folding portion of the mechanical arm. As discussed above, the re-spooling of the charging cord can be performed using a spring retraction mechanism or a motorized retraction mechanism.

The mechanical arm is moved to a designated location (818). In some implementations, moving the mechanical arm to a designated location includes placing the mechanical arm in a stowed state when charging is complete. For example, the control circuitry can monitor the charge state of the EV, and when the charge state reaches the complete charge state, the mechanical arm can be moved to the designated location, which can be a “home” location at which the mechanical arm remains when not in use.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The terms “data processing apparatus” and “control circuitry” encompass all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A system, comprising:
control circuitry; and
a mechanical arm communicatively connected to the control circuitry and configured to adjust a dispensing location of a charging cord, wherein the dispensing location is adjustable to different locations based on at least a first location of a first charging receptacle of a first vehicle and a second location of a second charging receptacle of a second vehicle, wherein the second location is further from a power source than the first location.

2. The system of claim 1, further comprising:
a mobile base configured to (i) move the mechanical arm toward a power source configured to provide power to the charging cord and (ii) move the mechanical arm away from the power source configured to provide power to the charging cord.

3. The system of claim 2, wherein the mechanical arm is attached to the mobile base and configured to move up and down the mobile base based on a first height of the first charging receptacle and a second height of the second charging receptacle.

4. The system of claim 2, further comprising a receptacle detection apparatus comprising one or more sensors and one or more processors, wherein the receptacle detection apparatus is configured to perform operations comprising:
detecting, based on data collected using the one or more sensors, the first location of the first charging receptacle or the second location of the second charging receptacle; and
aligning a physical location of a charging port of a charging station based on the detecting of the first location of the first charging receptacle or the second location of the second charging receptacle.

5. The system of claim 4, wherein the receptacle detection apparatus is configured to perform operations comprising:
connecting the charging port to a given charging receptacle; and
initiating charging, by the charging station, based, at least in part, on the charging port being electrically connected to the given charging receptacle.

6. The system of claim 5, wherein the receptacle detection apparatus is configured to perform operations comprising:
detecting when charging is complete; and
retracting the charging port from the given charging receptacle after the charging is complete.

7. The system of claim 6, wherein detecting when the charging is complete comprises detecting one or more of (i) when a charge cycle is complete while the charging port is still connected to the given charging receptacle or (ii) when the charging port has been physically removed from the given charging receptacle.

8. The system of claim 6, wherein retracting the charging port comprises one or more of (i) re-spooling a section of the charging cord or (ii) retracting a portion of a telescoping portion or folding portion of the mechanical arm.

9. The system of claim 1, wherein:
the base is located on an opposite side of a parking block than a power source providing power to the charging cord; and
the charging cord electrically connects the base to the power source, and is routed through the parking block.

10. The system of claim 1, wherein the mechanical arm comprises:
a telescoping portion or a folding portion; and
a cord dispenser attached to the telescoping portion or the folding portion, wherein the cord dispenser is configured to dispense and retract a portion of the charging cord.

11. The system of claim 10, wherein the cord dispenser comprises a spring retraction mechanism configured to retract the charging cord.

12. The system of claim 9, wherein the cord dispenser comprises a motorized retraction mechanism.

13. The system of claim 1, further comprising control circuitry configured to perform operations comprising identifying characteristics of a vehicle that is located within a given physical area.

14. The system of claim 13, wherein the control circuitry is configured to perform operations further comprising:
adjusting charging parameters of the charging station based on the characteristics of the vehicle that is located within the given physical area; and
moving the mechanical arm to a specified position based on the characteristics of the vehicle that is located within the given physical area.

15. The system of claim 14, wherein the control circuitry is configured to perform operations further comprising:
monitoring a charge state of the vehicle; and
moving the mechanical arm to a designated location based on the charge state of the vehicle reaching a charge complete state.

16. The system of claim 15, further comprising a solar power collection system configured to provide power to an electric vehicle charging station that includes the charger.

17. The system of claim 15, further comprising:
a parking block, comprising:
a top surface; and
a bottom surface, wherein the bottom surface is configured to be closer to the ground than the top surface when the parking block is in an installed state, wherein:
the parking block has a cord channel defined at a location within the parking block that is between the top surface and the bottom surface; and
the cord channel is a void configured to accept a cord that connects an electric vehicle (EV) charger to an EV charging port configured to physically connect to an EV.

18. The system of claim 17, wherein the cord channel is accessible through the bottom surface of the parking block.

19. The system of claim 17, wherein the cord channel is accessible from an exterior surface of the parking block.

20. The system of claim 19, wherein the cord channel is accessible from two exterior surfaces of the parking block.
